(19) United States
(12) Patent Application Publication
(10) Pub. No.: US 2025/0234346 A1
(43) Pub. Date: Jul. 17, 2025

(54) UPLINK TRANSMISSION DURING REFERENCE SIGNAL RECEPTION IN FULL-DUPLEX COMMUNICATION

(71) Applicant: QUALCOMM Incorporated, San Diego, CA (US)

(72) Inventors: Ahmed Attia ABOTABL, San Diego, CA (US); Diana MAAMARI, San Diego, CA (US); Abdelrahman Mohamed Ahmed Mohamed IBRAHIM, San Diego, CA (US); Muhammad Sayed Khairy ABDELGHAFFAR, San Jose, CA (US)

(21) Appl. No.: 18/410,834

(22) Filed: Jan. 11, 2024

(51) Int. Cl. H04W 72/1268; H04L 5/00; H04L 5/14; H04W 16/28; H04W 72/0446; H04W 72/541

(52) U.S. Cl. CPC H04W 72/1268; H04L 5/0051; H04L 5/14; H04W 16/28; H04W 72/0446; H04W 72/541

(57) ABSTRACT

Methods, systems, and devices for wireless communication are described. A user equipment (UE) with full-duplex capabilities may be configured with a self-interference threshold to be used for full-duplex communication during concurrent reception of a reference signal and transmission of an uplink communication. The UE may receive an allocation of uplink and downlink resources for full-duplex communication within the same time resource using a first set of parameters. If the uplink and downlink resources satisfy the self-interference threshold, the UE may communicate, within the time resource, via the uplink resources, to transmit an uplink communication, and the downlink resources, to receive a reference signal, using a second set of parameters.

### FIELD OF TECHNOLOGY

The following relates to wireless communication, including uplink transmission during reference signal reception in full-duplex communication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities, e.g., base stations, each supporting wireless communication for communication devices, which may be known as user equipment (UE).

### SUMMARY

The described techniques relate to improved methods, systems, devices, and apparatuses that support uplink transmission during reference signal reception in full-duplex communication. For example, the described techniques provide for a user equipment (UE) capable of full-duplex communication to receive control information (e.g., from a network entity) indicating a self-interference threshold for use during full-duplex communication. The self-interference threshold may be used when receiving a downlink communication including a reference signal (e.g., a synchronization signal block (SSB), a channel state information-reference signal (CSI-RS), or other tracking reference signal) while concurrently transmitting an uplink communication (e.g., a physical uplink control channel transmission (PUCCH), a physical uplink shared channel (PUSCH) transmission, a sounding reference signal (SRS), or other uplink transmission). The self-interference threshold may be used to ensure that self-interference at the UE, resulting from a proximity of uplink and downlink resources used for the full-duplex communication, is reduced. The UE may receive (e.g., from the network entity) a scheduling grant allocating the uplink and downlink resources for the full-duplex communication within a time resource (e.g., at least a partially overlapping time period) using a first set of parameters. Subsequently, based on the uplink resources and the downlink resources satisfying the self-interference threshold, the UE may communicate using a second set of parameters (e.g., instead of using the first set of parameters). The second set of parameters may represent parameters that occur after using one or more self-interference mitigation techniques to reduce self-interference during the full-duplex communication of the uplink transmission and the reference signal reception, relative to using the first set of parameters.

A method for wireless communications by a user equipment (UE) is described. The method may include receiving control information indicating a self-interference threshold for full-duplex communication during reception of a reference signal, receiving a scheduling grant allocating uplink resources and downlink resources for full-duplex communication within a time resource using a first set of parameters, and communicating via the uplink resources and the downlink resources within the time resource using a second set of parameters based on the uplink resources and the downlink resources satisfying the self-interference threshold.

A UE for wireless communications is described. The UE may include one or more memories storing processor executable code, and one or more processors coupled with the one or more memories. The one or more processors may individually or collectively operable to execute the code to cause the UE to receive control information indicating a self-interference threshold for full-duplex communication during reception of a reference signal, receive a scheduling grant allocating uplink resources and downlink resources for full-duplex communication within a time resource using a first set of parameters, and communicate via the uplink resources and the downlink resources within the time resource using a second set of parameters based on the uplink resources and the downlink resources satisfying the self-interference threshold.

Another UE for wireless communications is described. The UE may include means for receiving control information indicating a self-interference threshold for full-duplex communication during reception of a reference signal, means for receiving a scheduling grant allocating uplink resources and downlink resources for full-duplex communication within a time resource using a first set of parameters, and means for communicating via the uplink resources and the downlink resources within the time resource using a second set of parameters based on the uplink resources and the downlink resources satisfying the self-interference threshold.

A non-transitory computer-readable medium storing code for wireless communications is described. The code may include instructions executable by one or more processors to receive control information indicating a self-interference threshold for full-duplex communication during reception of a reference signal, receive a scheduling grant allocating uplink resources and downlink resources for full-duplex communication within a time resource using a first set of parameters, and communicate via the uplink resources and the downlink resources within the time resource using a second set of parameters based on the uplink resources and the downlink resources satisfying the self-interference threshold.

In some examples of the method, user equipment (UEs), and non-transitory computer-readable medium described herein, communicating via the uplink resources and the downlink resources using the second set of parameters may include operations, features, means, or instructions for transmitting an uplink communication using the uplink resources during the time resource while concurrently receiving the reference signal using the downlink resources during the time resource.

Some examples of the method, user equipment (UEs), and non-transitory computer-readable medium described herein may further include operations, features, means, or instructions for determining that a quantity of resource elements between a first resource element associated with the uplink resources and a second resource element associated with the downlink resources may be less than a threshold quantity of resource elements, where the self-interference threshold includes the threshold quantity of resource elements.

Some examples of the method, user equipment (UEs), and non-transitory computer-readable medium described herein may further include operations, features, means, or instructions for determining that the uplink resources and the downlink resources overlap in the time resource by a quantity of symbols that may be less than a threshold quantity of symbols, where the self-interference threshold includes the threshold quantity of symbols.

Some examples of the method, user equipment (UEs), and non-transitory computer-readable medium described herein may further include operations, features, means, or instructions for determining that a transmit power associated with an uplink communication associated with the uplink resources may be greater than a threshold transmit power level, where the self-interference threshold includes the threshold transmit power level.

Some examples of the method, user equipment (UEs), and non-transitory computer-readable medium described herein may further include operations, features, means, or instructions for determining that a spatial separation between a transmit beam associated with the uplink resources and a receive beam associated with the downlink resources may be less than a threshold spatial separation, where the self-interference threshold includes the threshold spatial separation.

Some examples of the method, user equipment (UEs), and non-transitory computer-readable medium described herein may further include operations, features, means, or instructions for determining, based on a receive beam used to receive the reference signal using the downlink resources, one or more restricted uplink beams, determining a transmit beam associated with an uplink transmission using the uplink resources, and determining that the uplink resources and the downlink resources satisfy the self-interference threshold based on determining that the transmit beam may be included in the one or more restricted uplink beams.

In some examples of the method, user equipment (UEs), and non-transitory computer-readable medium described herein, communicating via the uplink resources and the downlink resources using the second set of parameters may include operations, features, means, or instructions for puncturing a portion of the uplink resources to increase a quantity of resource elements between the uplink resources and the downlink resources within the time resource, shifting a portion of the uplink resources to increase a quantity of resource elements between the uplink resources and the downlink resources within the time resource, adjusting a transmit power of an uplink transmission associated with the uplink resources, adjusting a transmit beam associated with an uplink transmission associated with the uplink resources, or transmitting control signaling including a message indicating that the self-interference threshold was satisfied.

In some examples of the method, user equipment (UEs), and non-transitory computer-readable medium described herein, the uplink resources include symbols corresponding to a physical uplink control channel transmission, a physical uplink shared channel transmission, or a sounding reference signal.

In some examples of the method, user equipment (UEs), and non-transitory computer-readable medium described herein, the downlink resources include symbols corresponding to a synchronization signal block index configured for layer 1 reference signal received power measurement, activated semi-persistent channel-state information reference signal resources configured for layer 1 reference signal received power measurement, a periodic channel-state information reference signal resource configured for layer 1 reference signal received power measurement, aperiodic channel-state information reference signal resources configured for layer 1 reference signal received power measurement, or a combination thereof.

In some examples of the method, user equipment (UEs), and non-transitory computer-readable medium described herein, the UE may be triggered to measure at least a portion of the aperiodic channel-state information reference signal resources.

In some examples of the method, user equipment (UEs), and non-transitory computer-readable medium described herein, the control information may be received via radio resource control signaling, medium access control-control element signaling, downlink control information signaling, or a combination thereof.

In some examples of the method, user equipment (UEs), and non-transitory computer-readable medium described herein, the UE includes sub-band full-duplex capabilities.

### BRIEF DESCRIPTION OF THE DRAWINGS

FIG. 1 shows an example of a wireless communications system that supports uplink transmission during reference signal reception in full-duplex communication in accordance with one or more aspects of the present disclosure.

FIG. 2 shows an example of a portion of a wireless communications system that supports uplink transmission during reference signal reception in full-duplex communication in accordance with one or more aspects of the present disclosure.

FIGS. 3 through 6 show examples of communication resource configurations that support uplink transmission during reference signal reception in full-duplex communication in accordance with one or more aspects of the present disclosure.

FIG. 7 shows an example of a process flow that supports uplink transmission during reference signal reception in full-duplex communication in accordance with one or more aspects of the present disclosure.

FIGS. 8 and 9 show block diagrams of devices that support uplink transmission during reference signal reception in full-duplex communication in accordance with one or more aspects of the present disclosure.

FIG. 10 shows a block diagram of a communications manager that supports uplink transmission during reference signal reception in full-duplex communication in accordance with one or more aspects of the present disclosure.

FIG. 11 shows a diagram of a system including a device that supports uplink transmission during reference signal reception in full-duplex communication in accordance with one or more aspects of the present disclosure.

FIGS. 12 through 16 show flowcharts illustrating methods that support uplink transmission during reference signal reception in full-duplex communication in accordance with one or more aspects of the present disclosure.

### DETAILED DESCRIPTION

Various aspects of the present disclosure relate to techniques for uplink transmission during reference signal reception in full-duplex communication in wireless communications systems. In some wireless communications systems, one or more communication devices (e.g., a user equipment (UE) or a network entity) may operate in accordance with full-duplex communication. With full duplex communication, a communication device (e.g., a network entity or a UE) may be capable of or configured to concurrently transmit and receive data. For instance, a communication device operating in a full-duplex mode may receive signaling in a first transmission direction (e.g., downlink communications) and while concurrently transmitting signaling in a second transmission direction (e.g., uplink communications) in the same or similar frequency resources and time resources. The communication device operating in the full-duplex mode may be capable of in-band full-duplex (IBFD) communication, sub-band full-duplex (SBFD) communication (also referred to as flexible duplex), or a combination thereof. Full-duplex devices with IBFD communication capabilities may transmit and receive signaling using the same time and frequency resources. While full-duplex devices with SBFD communication capabilities may transmit and receive signaling using the same time resources, but different frequency resources (e.g., different portions (e.g., sub-bands) of the same frequency band). In some cases, operating in full-duplex mode may cause the communication device to experience self-interference as a result of leakage from the concurrent uplink and downlink transmissions. A UE that operates in full-duplex mode may communicate using IBFD communication, whereby the device may transmit and receive data using the same time and frequency resources (e.g., fully or partially overlapping resources), or may communicate using SBFD (in some cases referred to as flexible full duplex) communication, whereby the device may transmit and receive data using the same time resources, but different frequency resources.

For SBFD communication, the uplink and downlink resources may be placed in different portions (e.g., sub-bands) of the same frequency band. In such cases, the uplink and downlink resources may be separated, e.g., by a guard band, to mitigate self-interference at the UE. However, in some cases, the separation may be sufficiently small to potentially cause interference between the uplink and downlink resources. In some situations, when the UE may receive a relatively important downlink transmission from the network entity, such self-interference may be particularly problematic. For instance, in the case where a UE that is operating in SBFD receives a downlink transmission including a reference signal (e.g., a synchronization signal block (SSB), a channel state information-reference signal (CSI-RS), a tracking signal, or other reference signal) used for measurement by the UE, while concurrently transmitting an uplink transmission (e.g., a physical uplink control channel transmission (PUCCH), a physical uplink shared channel (PUSCH) transmission, a sounding reference signal (SRS), or other uplink transmission), any possible leakage between the uplink and downlink resources may cause inaccuracies with the UE's reference signal measurements. The UE may report the reference signal measurements to the network entity, but those measurements may be inaccurate due to the self-interference. In some cases, due to self-interference caused by potential leakage between uplink resources used for the uplink transmission and downlink resources used for reception of the reference signal, the UE might sense a high level of energy during measurement of the reference signal. The high level of energy may, at least, be in part due to energy from the uplink transmission, the self-interference, or a combination thereof. The detected high energy may cause inaccurate or biased measurements to be reported to the network entity. Because the network entity may base its scheduling and other decisions on such potentially inaccurate measurements, an overall reliability at the wireless communications system may be negatively impacted by the self-interference at the UE.

In accordance with various techniques described herein, improved techniques may enable mitigation of self-interference at a UE operating in accordance with full-duplex communication (e.g., SBFD communication). For instance, to mitigate self-interference at the UE resulting from leakage between uplink and downlink resources during full-duplex communication, the UE may be configured with a self-interference threshold (or in some cases, a plurality of self-interference thresholds). Based on whether the self-interference threshold is satisfied during the full-duplex communication, the UE may communicate using a first set of parameters or a second set of parameters. For instance, when the self-interference threshold is satisfied during concurrent uplink and downlink transmissions using the uplink and downlink resources, the UE may concurrently communicate via the uplink and downlink resources using the second set of parameters. The second set of parameters may be determined based on the UE to performing one or more mitigation techniques to reduce self-interference at the UE. When the self-interference threshold is not satisfied (e.g., when leakage between the uplink and downlink resources is unlikely), the UE may concurrently communicate via the uplink and downlink resources using the first set of parameters.

Aspects of the disclosure are initially described in the context of wireless communications systems. Aspects of the disclosure are further illustrated by and described with reference to apparatus diagrams, system diagrams, and flowcharts that relate to uplink transmission during reference signal reception in full-duplex communication.

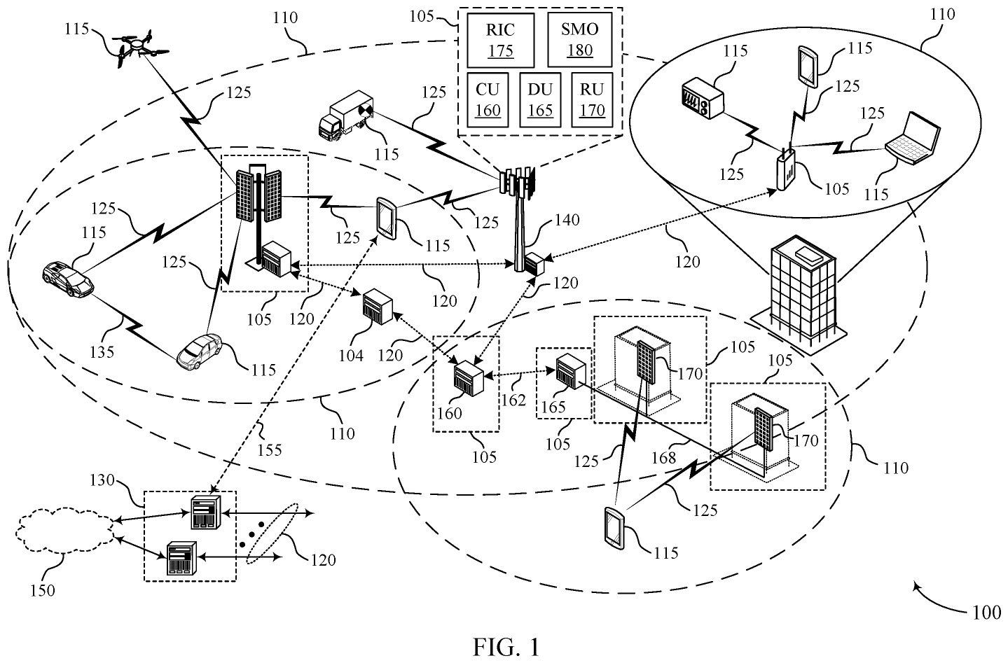

FIG. 1 shows an example of a wireless communications system 100 that supports uplink transmission during reference signal reception in full-duplex communication in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support uplink transmission during reference signal reception in full-duplex communication as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some implementations, a UE 115 may operate in accordance with full-duplex communication (e.g., SBFD communication) to transmit and receive uplink and downlink communications concurrently (e.g., within a same time resource or portion thereof). In such cases, self-interference may occur at the UE115 due to leakage between the uplink and downlink resources allocated for such communication. In some cases, such as when the UE 115 may be transmitting an uplink transmission while concurrently (e.g., during a same time resource) receiving a downlink transmission, e.g., a reference signal, to mitigate potential self-interference at the UE 115 during the concurrent transmissions, a network entity 105 may transmit, to the UE 115, control information indicating a self-interference threshold associated with allocated uplink resources, downlink resources, or both. Based on whether the self-interference threshold is satisfied, the UE 115 may communicate via the allocated uplink and the downlink resources within the same time resource (or portion thereof) using a first set of parameters or a second set of parameters. For instance, when the self-interference threshold is satisfied, the UE 115 communicate via the allocated uplink and downlink resources, within the same time resource (or portion thereof) using the second set of parameters. The second set of parameters may cause the UE 115 to perform one or more mitigation techniques to mitigate self-interference at the UE 115 during the full-duplex communication. In other instances, when the self-interference threshold is not satisfied, the concurrent uplink and downlink communication may be performed using the first set of parameters. In some cases, the first set of parameters may be a default set of parameters and may allow for full-duplex communication via the uplink and downlink resources within the same time resource (or portion thereof) without use of the one or more self-interference mitigation techniques. The described techniques may mitigate self-interference at the UE 115, such as during reception of one or more reference signals while concurrently transmitting uplink data, thereby safeguarding an accuracy of data, such as channel condition measurements, and ensuring overall communication reliability at the wireless communications system.

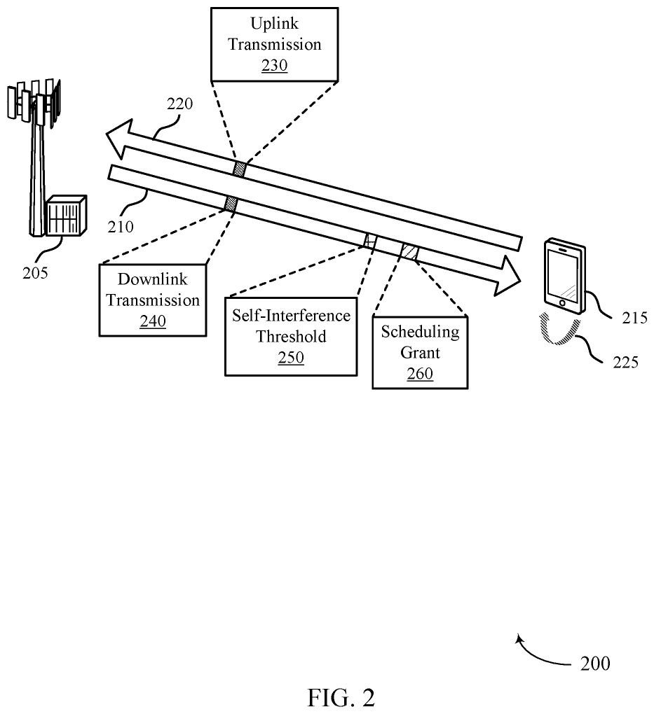

FIG. 2 shows an example of a portion of a wireless communications system 200 that supports uplink transmission during reference signal reception in full-duplex communication in accordance with one or more aspects of the present disclosure. The wireless communications system 200 may include a network entity 205 and a UE 215, which may be examples of network entities 105 and UEs 115, respectively, as described with reference to FIG. 1. The network entity 205 and UE 215 may communicate using communication links (e.g., a Uu link) in which the UE 215 may transmit uplink communications, such as uplink transmission 230, to the network entity 205, and the network entity 205 may transmit downlink communications, such as downlink transmission 240, to the UE 215.

The UE 215 may be configured to operate in a full-duplex mode, such that the UE 215 may be capable of both transmitting and receiving signals within the same time resources (e.g., during at least a portion of an overlapping period of time). In some cases, the UE 215 may support SBFD communication, and may be capable of transmitting and receiving signals on the same time resources, but on different frequency resources. For SBFD communication, the resources used for the uplink and downlink signals may be placed in different portions (e.g., different sub-bands) of the same frequency band. In such cases, the uplink and downlink resources may be separated, e.g., by a guard band, to mitigate self-interference 225 at the UE 215. For instance, if a separation between the uplink and downlink resources is not of a sufficient size, leakage between the uplink and downlink resources, during concurrent uplink and downlink communications, may result in the self-interference 225 at the UE 215. In some cases, to ensure that the separation between the uplink and downlink resources is sufficient to reduce self-interference 225 at the UE 215, the UE 215 may be configured with a self-interference threshold 250 (in some cases, the UE 215 may be configured with a plurality of self-interference thresholds). The self-interference threshold 250 may indicate a level, degree, or size of separation between, or associated with, the uplink and downlink resources that may be sufficient to mitigate the self-interference 225 at the UE 215. In some cases, the network entity 205 may transmit control information to the UE 215 including the self-interference threshold 250. In some cases, the control information may be included with a scheduling grant 260 allocating the uplink and downlink resources for the full-duplex communication. In some cases, the control information may be received in separate control signaling, such as via radio resource control (RRC) signaling, downlink control information (DCI), MAC-control element (MAC-CE) signaling, other control signaling, or a combination thereof.

In some cases, the control information may indicate a plurality of self-interference thresholds 250. In some cases, each of the plurality of self-interference thresholds 250 may relate to a threshold for separation of the uplink and downlink resources at a different domain of the resources, or may relate to a threshold for a characteristic associated with the uplink or downlink resources.

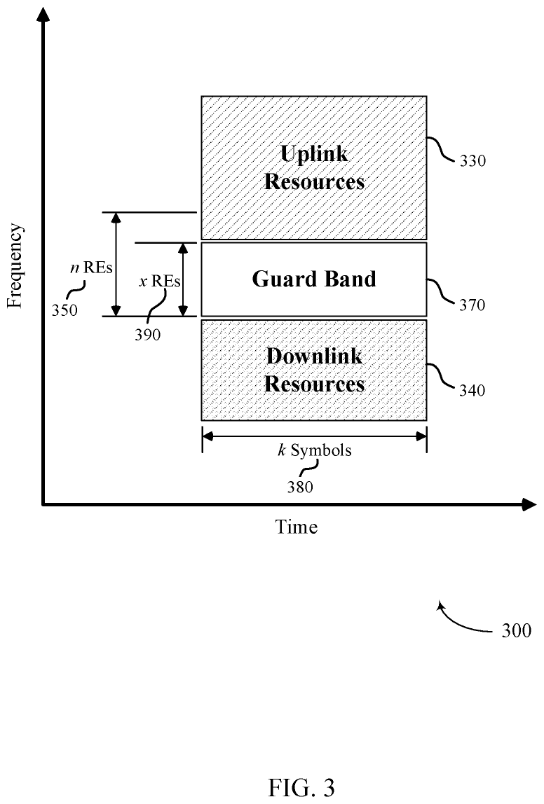

In some examples, the plurality of self-interference thresholds 250 may include a self-interference threshold 250 associated with a frequency domain of the uplink and downlink resources. For instance, the self-interference threshold 250 may be a threshold for ensuring sufficient separation between the frequency resources associated with the uplink and downlink resources. A self-interference threshold 250 for ensuring sufficient frequency separation is described in further detail with respect to FIG. 3.

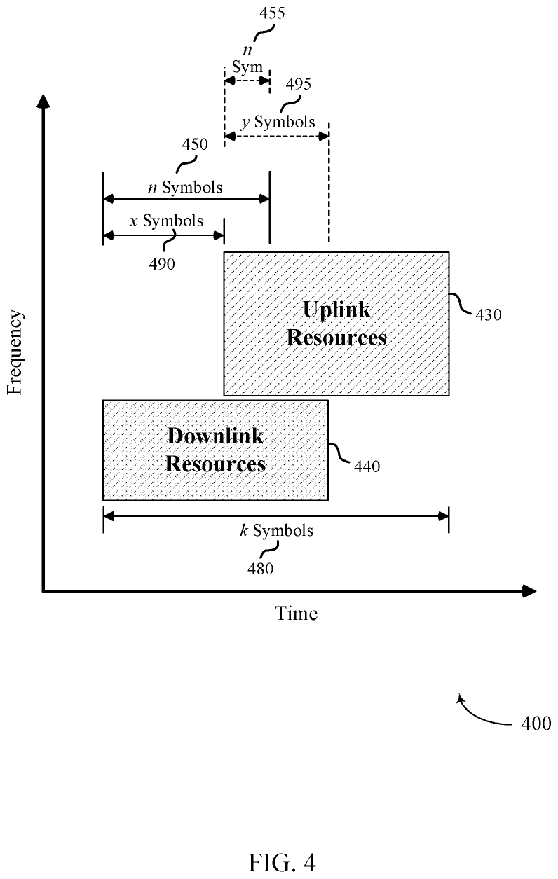

In some examples, the plurality of self-interference thresholds 250 may additionally, or alternatively, include a self-interference threshold 250 associated with a time domain of the uplink and downlink resources. For instance, the self-interference threshold 250 may be a threshold for ensuring sufficient separation between the time resources (e.g., at least a portion of the time resources) associated with the uplink and downlink resources. A self-interference threshold 250 for ensuring sufficient time separation is described in further detail with respect to FIG. 4.

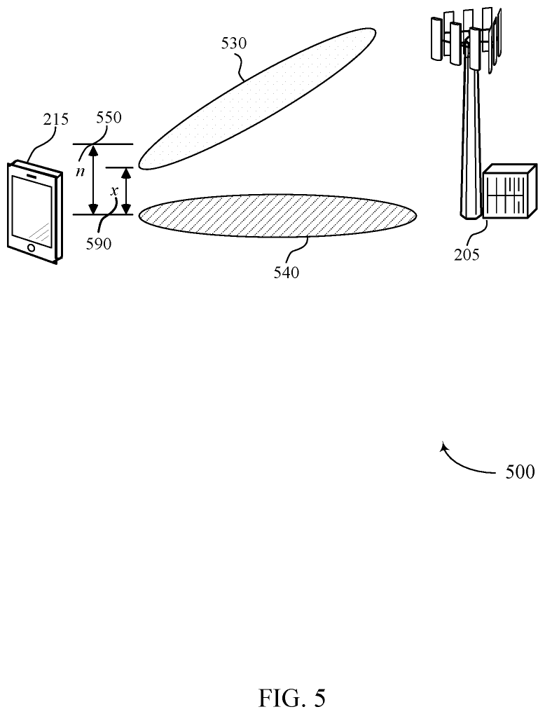

In some examples, the plurality of self-interference thresholds 250 may additionally, or alternatively, include a self-interference threshold 250 associated with a spatial domain of the uplink and downlink resources. For instance, the self-interference threshold 250 may be a threshold for ensuring sufficient separation between the spatial resources associated with the uplink and downlink resources. A self-interference threshold 250 for ensuring sufficient spatial separation is described in further detail with respect to FIG. 5.

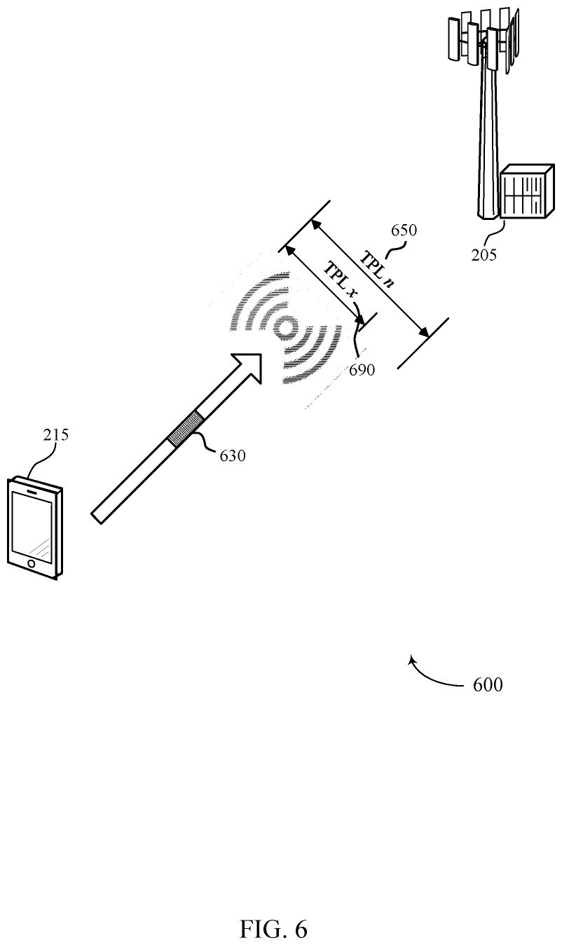

In some examples, the plurality of self-interference thresholds 250 may additionally, or alternatively, include a self-interference threshold 250 associated with a transmit power level of an uplink transmission associated with the uplink resources. For instance, the self-interference threshold may be a threshold for ensuring a transmit power level of an uplink transmission using the uplink resource may not impact reception of a downlink transmission using the downlink resources. A self-interference threshold 250 for ensuring an appropriate transmit power level is described in further detail with respect to FIG. 6.

The plurality of self-interference thresholds 250 may additionally include multiple self-interference thresholds 250 for one or more of the different above-described self-interference thresholds 250. For instance, the plurality of self-interference thresholds 250 may include multiple self-interference thresholds 250 associated with the frequency separation, multiple self-interference thresholds 250 associated with the time separation, multiple self-interference thresholds 250 associated with the spatial separation, multiple self-interference thresholds 250 associated with the transmit power level, or a combination thereof.

In some cases, each of the multiple self-interference thresholds may correspond to a self-interference threshold associated with a different class of full-duplex UEs 215. For instance, full-duplex UEs 215 capable of transmitting with high power may be characterized as a first class of full-duplex UEs 215, and full-duplex UEs 215 capable of transmitting only with low power may be characterized as a second class of full-duplex UEs 215. Accordingly, in some cases, the plurality of self-interference thresholds 250 may include a first set of self-interference thresholds 250 (e.g., self-interference thresholds 250 for frequency separation, time separation, spatial separation, and transmit power) that correspond to UEs 215 of the first class, and a second set of self-interference thresholds 250 (e.g., self-interference thresholds 250 for frequency separation, time separation, spatial separation, and transmit power) that correspond to UEs 215 of the second class. In some cases, there may be additional or different classes of full-duplex UEs 215 and corresponding self-interference thresholds 250. In some cases, each of the multiple self-interference thresholds may correspond to a self-interference threshold associated with a different channel or a different signal.

In some cases, the UE 215 may be configured with one or more of the plurality of self-interference thresholds 250 via RRC signaling. In some cases, an RRC configuration of the self-interference thresholds 250 may be overridden by a dynamic indication of one or more self-interference thresholds 250 received via DCI. In some cases, such as when the UE 215 is configured with multiple of a same type of self-interference threshold 250 (e.g., multiple frequency separation thresholds) via RRC signaling, DCI may be used to indicate a particular one of the self-interference thresholds 250 to be used by the UE 215.

In some cases, the control information may additionally include an indication of a first set of parameters, a second set of parameters, or both to be used for the full-duplex communication. For instance, the first set of parameters may be used for the full-duplex communication when a first set of conditions are met. In some cases, the first set of parameters may be a default set of parameters for the full-duplex communication. For instance, the first set of parameters may be used for the full-duplex communication when there is sufficient separation between the uplink and downlink resources (e.g., when the self-interference threshold 250 is not satisfied), such that self-interference 225 at the UE 215 is unlikely or is of an acceptable level. In some cases, certain types of transmissions may be restricted from full-duplex communication using the first set of parameters when the separation between the uplink and downlink resources is sufficient to mitigate self-interference 225. For example, if the separation between the uplink and downlink resources is sufficient to mitigate self-interference 225, and an uplink transmission scheduled for the uplink resources corresponds to a PUSCH transmission, a PUCCH transmission, or an SRS, but a downlink transmission scheduled for the downlink resources does not correspond to a restricted type of transmission, then the UE 215 may use the first set of parameters for the full-duplex communication using the uplink and downlink resources. Examples of restricted types of transmissions may include an SSB index configured for layer 1-reference signal received power (L1-RSRP) measurement, a periodic CSI-RS configured for L1-RSRP measurement, a semi-persistent CSI-RS configured for L1-RSRP measurement when the semi-persistent CSI-RS resources are activated, or an aperiodic CSI-RS configured for L1-RSRP measurement when the UE 215 is triggered to measure at least a portion of the aperiodic CSI-RS resources.

The second set of parameters may be used for the full-duplex communication when a second set of conditions are met. For instance, the second set of parameters may be used for the full-duplex communication when there is insufficient separation between the uplink and downlink resources (e.g., when the self-interference threshold 250 is satisfied), such that self-interference 225 at the UE 215 is likely or is of a level that may impact an ability for the UE 215 to successfully receive and decode a downlink transmission or transmit an uplink transmission. The second set of parameters may be determined after it is determined whether a self-interference threshold is satisfied. If the self-interference threshold is satisfied, one or more of the first set of parameters may be adjusted to determine the second set of parameters. Examples of changes to the first parameters that could occur to determine the second set of parameters may include shifting a frequency range for one of the communications, shifting one of the communications in time, puncturing one of the communications, adjusting the transmit power of one of the communications, and/or shifting a beam direction of one of the communications. In some cases, when a downlink transmission scheduled for the downlink resource corresponds to a type of the transmissions restricted from full-duplex communication and the self-interference threshold is satisfied, interference mitigation techniques may be employed to determine the second set of parameters. For example, if the separation between the uplink and downlink resources is insufficient to mitigate self-interference 225, and an uplink transmission scheduled for the uplink resources corresponds to a PUSCH transmission, a PUCCH transmission, or an SRS, and a downlink transmission scheduled for the downlink resources corresponds to one of the restricted type of transmissions, such as an SSB index configured for L1-RSRP measurement, a periodic CSI-RS configured for L1-RSRP measurement, a semi-persistent CSI-RS configured for L1-RSRP measurement when the semi-persistent CSI-RS resources are activated, or an aperiodic CSI-RS configured for L1-RSRP measurement when the UE 215 is triggered to measure at least a portion of the aperiodic CSI-RS resources, then the UE 215 may use the second set of parameters for the full-duplex communication using the uplink and downlink resources.

The first and second sets of parameters may include one or more parameters for the full-duplex communication. For instance, the first and second sets of parameters may include parameters associated with an adjustment to a transmit beam for transmitting an uplink transmission associated with the uplink resources, a modulation and coding scheme (MCS) for transmitting an uplink transmission associated with the uplink resources, power control information for transmitting an uplink transmission associated with the uplink resources, an indication to puncture at least a portion of the uplink resources, an indication to shift a location of an uplink transmission within the uplink resources, an indication to report potential self-interference to the network entity 205, an indication to drop an uplink transmission, an indication to drop a downlink transmission, or a combination thereof.

FIG. 3 shows an example of a communication resource configuration 300 that supports uplink transmission during reference signal reception in full-duplex communication in accordance with one or more aspects of the present disclosure.

In the example configuration 300, the UE 215 may receive, from the network entity 205, control signaling including a scheduling grant 260 allocating uplink resources and downlink resources to the UE 215 for full-duplex communication. The uplink resources and the downlink resources may include time resources (such as an allocation of time slots, symbols, or the like), frequency resources (such as an allocation of frequency bands, resource blocks, resource elements, or the like), and spatial resources (such as an allocation of spatial channels, beams, or the like).

In some cases, the allocated resources may be for SBFD communication in particular, where the UE 215 may transmit and receive data using a same time resource 380, but different frequency resources, such as uplink resources 330 and downlink resources 340. For the SBFD communication, the uplink resources 330 and downlink resources 340 may be placed in different portions (e.g., sub-bands) of the same frequency band, and the uplink resources 330 and downlink resources 340 may be separated by a guard band 370 to mitigate self-interference 225 at the UE 215 caused by the SBFD communication.

In some cases, the control signaling including the scheduling grant may additionally include control information indicating a first set of parameters, a second set of parameters, one or more self-interference thresholds, or a combination thereof to be used for the full-duplex communication. In some cases, the control information may be received, from the network entity 205, in separate control signaling.

The first set of parameters may be used for the full-duplex communication when a first set of conditions are met, and the second set of parameters may be used for the full-duplex communication when a second set of conditions are met, as described with respect to FIG. 2.

The one or more self-interference thresholds may include a self-interference threshold 350 associated with a frequency domain of the uplink resources 330 and the downlink resources 340. The self-interference threshold 350 may be used to ensure that a sufficient separation exists between the frequency resources associated with uplink resources 330 and the downlink resources 340 allocated to the UE 215. That is, the self-interference threshold 350 may be used to determine whether a size 390 of the guard band 370 is sufficient to mitigate self-interference 225 at the UE 215 resulting from full-duplex communication using the uplink resources 330 and the downlink resources 340. The self-interference threshold 350 may indicate a quantity of resource elements or resource blocks, such as n resource elements. The self-interference threshold 350 may be compared with the size 390 of the guard band 370 to determine whether the uplink resources 330 and the downlink resources 340 are sufficiently separated in the frequency domain.

In some cases, if the size 390 of the guard band 370 is greater than the self-interference threshold 350 (e.g., does not satisfy the self-interference threshold 350), the UE 215 may determine that the frequency separation is sufficient to mitigate self-interference 225 at the UE 215 and the UE 215 may communicate concurrently, such as during the time resource 380 (or at least a portion of the time resource 380), via the uplink resources 330 and the downlink resources 340 using the first set of parameters. On the other hand, if the size 390 of the guard band 370 is less than or equal to the self-interference threshold 350 (e.g., satisfies the self-interference threshold 350), the UE 215 may determine that the frequency separation is insufficient to mitigate self-interference 225 at the UE 215, and as a result, may communicate concurrently, such as during the time resource 380 (or at least a portion of the time resource 380), via the uplink resources 330 and the downlink resources 340 using the second set of parameters.

In some cases, when the UE 215 determines that the size 390 of the guard band 370 is less than or equal to the self-interference threshold 350 (e.g., satisfies the self-interference threshold 350 and has a frequency separation that is insufficient to mitigate self-interference 225), may determine whether a type of a downlink transmission scheduled for concurrent communication using the downlink resources 340 is of a restricted type of transmission. That is, in some cases, only certain types of transmissions may be restricted from full-duplex communication using the first set of parameters when the separation between the uplink resources 330 and downlink resources 340 is insufficient to mitigate the self-interference 225 (e.g., when the self-interference threshold 350 is satisfied). For example, if the size 390 of the guard band 370 is less than or equal to the self-interference threshold 350 (e.g., satisfies the self-interference threshold 350), and an uplink transmission scheduled for the uplink resources 330 corresponds to a PUSCH transmission, a PUCCH transmission, or an SRS, but a downlink transmission scheduled for the downlink resources 340 does not correspond to a restricted type of downlink transmission, then the UE 215 may use the first set of parameters for the full-duplex communication using the uplink resources 330 and the downlink resources 340. Examples of the restricted types of downlink transmissions may include such as an SSB index configured for L1-RSRP measurement, a periodic CSI-RS configured for L1-RSRP measurement, a semi-persistent CSI-RS configured for L1-RSRP measurement when the semi-persistent CSI-RS resources are activated, or an aperiodic CSI-RS configured for L1-RSRP measurement when the UE 215 is triggered to measure at least a portion of the aperiodic CSI-RS resources. On the other hand, if the size 390 of the guard band 370 is less than or equal to the self-interference threshold 350 (e.g., satisfies the self-interference threshold 350), and the downlink transmission scheduled for the downlink resources 340 corresponds to one of the restricted types of downlink transmissions, then the UE 215 may use the second set of parameters for the full-duplex communication using the uplink resources 330 and the downlink resources 340.

Use of the second set of parameters may enable the UE 215 to mitigate self-interference 225 during the full-duplex communication using the uplink resources 330 and the downlink resources 340 during the same time resource 380 (or at least a portion of the same time resource 380). Use of the first set of parameters may enable the UE 215 to perform the full-duplex communication using the uplink resources 330 and the downlink resources 340 during the same time resource 380 (or at least a portion of the same time resource 380) without performing the one or more self-interference mitigation techniques.

The UE 215 may determine which of the one or more self-interference mitigation techniques to use based, at least in part, on a priority associated with an uplink transmission scheduled to use the uplink resources 330, a priority associated with a downlink transmission scheduled to use the downlink resources 340, or both. The one or more mitigation techniques may include puncturing at least a portion of the uplink resources 330 to increase a quantity of resource elements or resource blocks between the uplink resources 330 and the downlink resources 340 (and also reducing the quantity of resource elements used by the punctured communication). In some cases, the puncturing may cause the quantity of resource elements or resource blocks between the uplink resources 330 and the downlink resources 340 to be greater than the self-interference threshold 350. For instance, the puncturing may cause the UE 215 not to transmit portions of the uplink transmission on resource elements within the self-interference threshold 350. In some cases, the UE 215 may determine to perform the puncturing based on determining that a priority associated with a downlink transmission scheduled to use the downlink resources 340 is higher than a priority associated with an uplink transmission scheduled to use the uplink resources 330.

Additionally, or alternatively, the one or more self-interference mitigation techniques may include shifting a location, within the uplink resources 330, of an uplink transmission to increase a quantity of resource elements or resource blocks between the uplink resources 330 and the downlink resources 340. In some cases, the shifting may cause the quantity of resource elements or resource blocks between the uplink resources 330 and the downlink resources 340 to be greater than the self-interference threshold 350. For instance, the shifting may cause the uplink transmission to be shifted to avoid using resources elements or resource blocks that are within the self-interference threshold 350. In some cases, the UE 215 may determine to perform the shifting based on determining that a priority associated with a downlink transmission scheduled to use the downlink resources 340 is higher than a priority associated with an uplink transmission scheduled to use the uplink resources 330.

Additionally, or alternatively, the one or more self-interference mitigation techniques may include transmitting, to the network entity 205, a message including a notification that uplink and downlink transmissions associated with the uplink resources 330 and downlink resources 340 occurred during the time resource 380 while the size 390 of the guard band 370 was insufficient to mitigate self-interference 225 at the UE 215 (e.g., when the self-interference threshold 350 is satisfied). In this way, the network entity 205 may be aware that any measurements that the UE 215 performs based on such downlink communications and transmits to the network entity 205 may be biased due to the potential self-interference 225. In some cases, the UE 215 may determine to transmit the notification to the network entity 205 based on determining that a priority associated with a downlink transmission scheduled to use the downlink resources 340 is the same as a priority associated with an uplink transmission scheduled to use the uplink resources 330.

Additionally, or alternatively, the one or more self-interference mitigation techniques may include dropping an uplink transmission scheduled to use the uplink resources 330 or dropping a downlink transmission scheduled to use the downlink resources 340. The UE 215 may determine which of the uplink or the downlink transmission to drop based on a priority associated with each. For instance, based on determining that a priority associated with the uplink transmission is higher than a priority associated with the downlink transmission, the downlink transmission may be ignored or discarded instead of used for its intended purpose. On the other hand, if a priority associated with the downlink transmission is higher than a priority associated with the uplink transmission, then the uplink transmission may be dropped.

FIG. 4 shows an example of a communication resource configuration 400 that supports uplink transmission during reference signal reception in full-duplex communication in accordance with one or more aspects of the present disclosure.

In the example configuration 400, the UE 215 may receive, from the network entity 205, control signaling including a scheduling grant 260 allocating uplink resources and downlink resources to the UE 215 for full-duplex communication. The uplink resources and the downlink resources may include time resources (such as an allocation of time slots, symbols, or the like), frequency resources (such as an allocation of frequency bands, resource blocks, resource elements, or the like), and spatial resources (such as an allocation of spatial channels, beams, or the like).

In some cases, the allocated resources may be for SBFD communication in particular, where the UE 215 may transmit and receive data using at least a portion of a same time resource 480, but different frequency resources, such as uplink resources 430 and downlink resources 440. For the SBFD communication, the uplink resources 430 and downlink resources 440 may be placed in different portions (e.g., sub-bands) of the same frequency band. In some cases, the uplink resources 430 and downlink resources 440 may be separated by a guard band to mitigate self-interference 225 at the UE 215 as during the SBFD communication. In some cases (such as illustrated), the uplink resources 430 and the downlink resource 440 may not be separated by a guard band. In some cases, a start of the uplink resources 430 and a start of the downlink resources 440 may be separated by a time offset 490 to mitigate self-interference 225 at the UE 215 during of the SBFD communication.

In some cases, the control signaling including the scheduling grant may additionally include control information indicating a first set of parameters, a second set of parameters, one or more self-interference thresholds, or a combination thereof to be used for the full-duplex communication. In some cases, the control information may be received, from the network entity 205, in separate control signaling.

The first set of parameters may be used for the full-duplex communication when a first set of conditions are met, and the second set of parameters may be used for the full-duplex communication when a second set of conditions are met, as described with respect to FIG. 2.

The one or more self-interference thresholds may include a self-interference threshold 450 associated with a time domain of the uplink resources 430 and the downlink resources 440. The self-interference threshold 450 may be used to ensure that a sufficient separation (e.g., time offset) exists between the time resources associated with uplink resources 430 and the downlink resources 440 allocated to the UE 215. That is, the self-interference threshold 450 may be used to determine whether the time offset 490 (e.g., a quantity of symbols between a first symbol of the downlink resources 440 and a first symbol of the uplink resources 430) is sufficient to mitigate self-interference 225 at the UE 215 resulting from full-duplex communication using the uplink resources 430 and the downlink resources 440. The self-interference threshold 450 may indicate a quantity of symbols, such as n symbols, and the self-interference threshold 450 may be compared with the time offset 490 to determine whether the uplink resources 430 and the downlink resources 440 are sufficiently separated in the time domain.

In some cases, if the time offset 490 between the uplink resources 430 and the downlink resources 440 is greater than the self-interference threshold 450 (e.g., does not satisfy the self-interference threshold 450), the UE 215 may determine that the time separation is sufficient to mitigate self-interference 225 at the UE 215 and the UE 215 may communicate concurrently, such as during at least a portion of the time resource 480, via the uplink resources 430 and the downlink resources 440 using the first set of parameters. On the other hand, if the time offset 490 between the uplink resources 430 and the downlink resources 440 is less than or equal to the self-interference threshold 450 (e.g., satisfies the self-interference threshold 450), the UE 215 may determine that the time separation is insufficient to mitigate self-interference 225 at the UE 215, and as a result, may communicate concurrently, such as during the at least a portion of the time resource 480, via the uplink resources 430 and the downlink resources 440 using the second set of parameters.

In some cases, when the UE 215 determines that the time offset 490 between the uplink resources 430 and the downlink resources 440 is less than or equal to the self-interference threshold 450 (e.g., satisfies the self-interference threshold 450 and has a time separation that is insufficient to mitigate self-interference 225), the UE 215 may first determine whether a type of downlink transmission scheduled for concurrent communication using the downlink resources 440 is of a restricted type of transmission. That is, in some cases, certain types of transmissions may be restricted from full-duplex communication using the first set of parameters when the separation between the uplink resources 430 and downlink resources 440 is insufficient to mitigate the self-interference 225 (e.g., when the self-interference threshold 450 is satisfied). For example, if the time offset 490 between the uplink resources 430 and the downlink resources 440 is less than or equal to the self-interference threshold 450 (e.g., satisfies the self-interference threshold 450), and an uplink transmission scheduled for the uplink resources 430 corresponds to a PUSCH transmission, a PUCCH transmission, or an SRS, but a downlink transmission scheduled for the downlink resources 440 does not correspond to a restricted type of transmission, such as an SSB index configured for L1-RSRP measurement, a periodic CSI-RS configured for L1-RSRP measurement, a semi-persistent CSI-RS configured for L1-RSRP measurement when the semi-persistent CSI-RS resources are activated, or an aperiodic CSI-RS configured for L1-RSRP measurement when the UE 215 is triggered to measure at least a portion of the aperiodic CSI-RS resources, then the UE 215 may use the first set of parameters for the full-duplex communication using the uplink resources 430 and the downlink resources 440. On the other hand, if the time offset 490 between the uplink resources 430 and the downlink resources 440 is less than or equal to the self-interference threshold 450 (e.g., satisfies the self-interference threshold 450), and the uplink transmission scheduled for the uplink resources 430 corresponds to a PUSCH transmission, a PUCCH transmission, or an SRS, and the downlink transmission scheduled for the downlink resources 440 corresponds to a restricted type of transmission, such as an SSB index configured for L1-RSRP measurement, a periodic CSI-RS configured for L1-RSRP measurement, a semi-persistent CSI-RS configured for L1-RSRP measurement when the semi-persistent CSI-RS resources are activated, or an aperiodic CSI-RS configured for L1-RSRP measurement when the UE 215 is triggered to measure at least a portion of the aperiodic CSI-RS resources, then the UE 215 may use the second set of parameters for the full-duplex communication using the uplink resources 430 and the downlink resources 440.

Use of the second set of parameters may enable the UE 215 to mitigate self-interference 225 during the full-duplex communication using the uplink resources 430 and the downlink resources 440 during at least a portion of the same time resource 480. Use of the first set of parameters may enable the UE 215 to perform the full-duplex communication using the uplink resources 430 and the downlink resources 440 during at least a portion of the same time resource 480 without performing the one or more mitigation techniques.

The UE 215 may determine which of the one or more self-interference mitigation techniques to use based, at least in part, on a priority associated with an uplink transmission scheduled to use the uplink resources 430, a priority associated with a downlink transmission scheduled to use the downlink resources 440, or both. The one or more self-interference mitigation techniques may include puncturing at least a portion of the uplink resources 430 to increase a quantity of symbols between the uplink resources 430 and the downlink resources 440. In some cases, the puncturing may cause the quantity of symbols between a start of the uplink resources 430 and a start of the downlink resources 440 to be greater than the self-interference threshold 450. For instance, the puncturing may cause the UE 215 not to transmit portions of the uplink transmission on symbols within the self-interference threshold 450. In some cases, the UE 215 may determine to perform the puncturing based on determining that a priority associated with a downlink transmission scheduled to use the downlink resources 440 is higher than a priority associated with an uplink transmission scheduled to use the uplink resources 430.

Additionally, or alternatively, the one or more self-interference mitigation techniques may include shifting a location, within the uplink resources 430, of an uplink transmission to increase a quantity of symbols between a start of the uplink resources 430 and a start of the downlink resources 440. In some cases, the shifting may cause the quantity of symbols between the start of the uplink resources 430 and the start of the downlink resources 440 to be greater than the self-interference threshold 450. For instance, the shifting may cause the uplink transmission to be shifted to avoid using symbols that are within the self-interference threshold 450. In some cases, the UE 215 may determine to perform the shifting based on determining that a priority associated with a downlink transmission scheduled to use the downlink resources 440 is higher than a priority associated with an uplink transmission scheduled to use the uplink resources 430.

Additionally, or alternatively, the one or more self-interference mitigation techniques may include transmitting, to the network entity 205, a message including a notification that uplink and downlink transmissions associated with the uplink resources 430 and downlink resources 440 occurred during at least a portion of the time resource 480, while the time offset 490 was insufficient to mitigate self-interference 225 at the UE 215 (e.g., when the self-interference threshold 450 is satisfied). In this way, the network entity 205 may be aware that any measurements that the UE 215 performs based on such downlink communications may be biased due to the potential self-interference 225 at the UE 215. In some cases, the UE 215 may determine to transmit the notification to the network entity 205 based on determining that a priority associated with a downlink transmission scheduled to use the downlink resources 440 is the same as a priority associated with an uplink transmission scheduled to use the uplink resources 430.

Additionally, or alternatively, the one or more self-interference mitigation techniques may include dropping an uplink transmission scheduled to use the uplink resources 430 or dropping a downlink transmission scheduled to use the downlink resources 440. The UE 215 may determine which of the uplink or the downlink transmission to drop based on a priority associated with each. For instance, based on determining that a priority associated with the uplink transmission is higher than a priority associated with the downlink transmission, the downlink transmission may be dropped. On the other hand, if a priority associated with the downlink transmission is higher than a priority associated with the uplink transmission, then the uplink transmission may be dropped.

In some examples, instead of representing an offset of time from a start of the downlink resource 440 to a start of the uplink resource 430 that may be sufficient to mitigate self-interference 225 at the UE 215, a self-interference threshold 455 may instead represent a period of overlap of the uplink resources 430 and the downlink resources 440 that may be sufficient to mitigate self-interference 225 at the UE 215. In such cases, instead of comparing the self-interference threshold 450 to the time offset 490, self-interference threshold 455 may, instead, be compared with an overlapping period 495 between the uplink resources 430 and the downlink resources 440 to determine whether the uplink resources 430 and the downlink resources 440 are sufficiently separated in the time domain. For instance, when the overlapping period 495 is less than the self-interference threshold 455 (e.g., does not satisfy the self-interference threshold 455), the UE 215 may determine that the time separation is sufficient to mitigate self-interference 225 at the UE 215. When the overlapping period 495 is greater than or equal to the self-interference threshold 455 (e.g., does satisfy the self-interference threshold 455), the UE may determine that the time separation is insufficient to mitigate self-interference 225 at the UE 215. The UE 215 may subsequently communicate using the first set of parameters or the second set of parameters or using the one or more self-interference mitigation techniques, as described above.

In some cases, the above-described self-interference threshold requirements related to sufficient separation in the time domain may be used together with the self-interference threshold requirements related to sufficient separation in the frequency domain, as described with respect to FIG. 3.

FIG. 5 shows an example of a communication resource configuration 500 that supports uplink transmission during reference signal reception in full-duplex communication in accordance with one or more aspects of the present disclosure.

In the example configuration 500, the UE 215 may receive, from the network entity 205, control signaling including a scheduling grant 260 allocating uplink resources and downlink resources to the UE 215 for full-duplex communication. The uplink resources and the downlink resources may include time resources (such as an allocation of time slots, symbols, or the like), frequency resources (such as an allocation of frequency bands, resource blocks, resource elements, or the like), and spatial resources (such as an allocation of spatial channels, beams, or the like).

In some cases, the allocated resources may be for SBFD communication in particular, where the UE 215 may transmit and receive data using a same time resource (or at least a portion of the same time resource), but different frequency resources. For the SBFD communication, the uplink and downlink resources may be placed in different portions (e.g., sub-bands) of the same frequency band. In some cases, the uplink and downlink frequency resources may be separated by a guard band to mitigate self-interference 225 at the UE 215 during the SBFD communication. In some cases, the uplink and downlink resource may not be separated by a guard band. In some cases, a start of the uplink and downlink time resources may be separated by a time offset to mitigate self-interference 225 at the UE 215 during the SBFD communication. In some cases, there may be no time offset separating a start of the uplink and downlink time resources. In some cases, uplink resources, such as an allocated transmit beam 530, and downlink resources, such as an allocated receive beam 540 may be separated by a beamwidth amount or angular separation amount to mitigate self-interference 225 at the UE 215 during the SBFD communication.

In some cases, the control signaling including the scheduling grant may additionally include control information indicating a first set of parameters, a second set of parameters, one or more self-interference thresholds, or a combination thereof to be used for the full-duplex communication. In some cases, the control information may be received, from the network entity 205, in separate control signaling.

The first set of parameters may be used for the full-duplex communication when a first set of conditions are met, and the second set of parameters may be used for the full-duplex communication when a second set of conditions are met, as described with respect to FIG. 2.

The one or more self-interference thresholds may include a self-interference threshold 550 associated with spatial separation of the transmit beam 530 and the receive beam 540. The self-interference threshold 550 may be used to ensure that a sufficient spatial separation exists between the transmit beam 530 and the receive beam 540. That is, the self-interference threshold 550 may be used to determine whether a spatial separation amount 590 (e.g., beamwidth amount or an angular separation amount) is sufficient to mitigate self-interference 225 at the UE 215 resulting from full-duplex communication using the transmit beam 530 and the receive beam 540. The self-interference threshold 550 may indicate an amount of beamwidth or an amount of angular separation, such as n, and the self-interference threshold 550 may be compared with the spatial separation amount 590 to determine whether the transmit beam 530 and the receive beam 540 are sufficiently separated in the spatial domain.

In some cases, if the spatial separation amount 590 between the transmit beam 530 and the receive beam 540 is greater than the self-interference threshold 550 (e.g., does not satisfy the self-interference threshold 550), the UE 215 may determine that the spatial separation is sufficient to mitigate self-interference 225 at the UE 215 and the UE 215 may communicate concurrently, such as during at least a portion of a time resource, using the transmit beam 530 and the receive beam 540 and using the first set of parameters. On the other hand, if the spatial separation amount 590 between the transmit beam 530 and the receive beam 540 is less than or equal to the self-interference threshold 550 (e.g., satisfies the self-interference threshold 550), the UE 215 may determine that the spatial separation is insufficient to mitigate self-interference 225 at the UE 215, and as a result, may communicate concurrently, such as during the at least a portion of the time resource, using the transmit beam 530 and the receive beam 540 and using the second set of parameters.

In some cases, when the UE 215 determines that the spatial separation amount 590 between the transmit beam 530 and the receive beam is less than or equal to the self-interference threshold 550 (e.g., satisfies the self-interference threshold 550 and has a spatial separation that is insufficient to mitigate self-interference 225), the UE 215 may first determine whether a type of downlink transmission scheduled for concurrent communication using the receive beam 540 if of a restricted type of transmission. That is, in some cases, only certain types of transmissions may be restricted from full-duplex communication using the first set of parameters when the separation between the transmit beam 530 and the receive beam 540 is insufficient to mitigate the self-interference 225 (e.g., when the self-interference threshold 550 is satisfied). For example, if the spatial separation amount 590 between the transmit beam 530 and the receive beam 540 is less than or equal to the self-interference threshold 550 (e.g., satisfies the self-interference threshold 550), and an uplink transmission scheduled for transmission using the transmit beam 530 corresponds to a PUSCH transmission, a PUCCH transmission, or an SRS, but a downlink transmission scheduled for reception using the receive beam 540 does not correspond to one of the restricted types of transmissions, such as an SSB index configured for L1-RSRP measurement, a periodic CSI-RS configured for L1-RSRP measurement, a semi-persistent CSI-RS configured for L1-RSRP measurement when the semi-persistent CSI-RS resources are activated, or an aperiodic CSI-RS configured for L1-RSRP measurement when the UE 215 is triggered to measure at least a portion of the aperiodic CSI-RS resources, then the UE 215 may use the first set of parameters for the full-duplex communication using the transmit beam 530 and the receive beam 540. On the other hand, if the spatial separation amount 590 between the transmit beam 530 and the receive beam 540 is less than or equal to the self-interference threshold 550 (e.g., satisfies the self-interference threshold 550), and the uplink transmission scheduled for transmission using the transmit beam 530 corresponds to a PUSCH transmission, a PUCCH transmission, or an SRS, and the downlink transmission scheduled for reception using the receive beam 540 corresponds to an SSB index configured for L1-RSRP measurement, a periodic CSI-RS configured for L1-RSRP measurement, a semi-persistent CSI-RS configured for L1-RSRP measurement when the semi-persistent CSI-RS resources are activated, or an aperiodic CSI-RS configured for L1-RSRP measurement when the UE 215 is triggered to measure at least a portion of the aperiodic CSI-RS resources, then the UE 215 may use the second set of parameters for the full-duplex communication using the transmit beam 530 and the transmit beam 540.

Use of the second set of parameters may enable the UE 215 to mitigate self-interference 225 during the full-duplex communication using the transmit beam 530 and the receive beam 540 during at least a portion of a same time resource. Use of the first set of parameters may enable the UE 215 to perform the full-duplex communication using the transmit beam 530 and the receive beam 540 during at least a portion of the same time resource without performing the one or more mitigation techniques.

The UE 215 may determine which of the one or more self-interference mitigation techniques to use based, at least in part, on a priority associated with an uplink transmission scheduled to use the transmit beam 530, a priority associated with a downlink transmission scheduled to use the receive beam 540, or both. The one or more self-interference mitigation techniques may include adjusting the transmit beam 530 in accordance with a criterion (e.g., a pre-configured criterion). For instance, adjusting the transmit beam 530 may include adjusting one or more beamforming weights or parameters associated with the transmit beam 530, adjusting a phase or amplitude of antenna elements associated with the UE 215, adjusting modulation and coding schemes, adjusting a transmit power, making other adjustments, or any combination thereof in order to sufficiently separate the transmit beam 530 from the receive beam 540 in the spatial domain. For instance, the adjusting may cause the transmit beam 530 and the receive beam 540 to be separated by a spatial separation amount 590 that is greater than the self-interference threshold 550. In some cases, the UE 215 may determine to perform the adjusting based on determining that a priority associated with a downlink transmission scheduled to use the receive beam 540 is higher than a priority associated with an uplink transmission scheduled to use the transmit beam 530.

Additionally, or alternatively, the one or more self-interference mitigation techniques may include changing the transmit beam 530. For instead, the UE 215 may switch the transmit beam 530 from a first beam to a second beam to sufficiently spatially separate the transmit beam 530 from the receive beam 540. For instance, changing the transmit beam 530 from a first beam to a second beam may cause the transmit beam 530 and the receive beam 540 to be separated by a spatial separation amount 590 that is greater than the self-interference threshold 550. In some cases, the UE 215 may determine to perform the adjusting based on determining that a priority associated with a downlink transmission scheduled to use the receive beam 540 is higher than a priority associated with an uplink transmission scheduled to use the transmit beam 530.

Additionally, or alternatively, the one or more self-interference mitigation techniques may include transmitting, to the network entity 205, a message including a notification that uplink and downlink transmissions associated with the transmit beam 530 and receive beam 540 occurred during at least a portion of the same time resource (e.g., concurrently) while the spatial separation amount 590 was insufficient to mitigate self-interference 225 at the UE 215 (e.g., when the self-interference threshold 550 is satisfied). In this way, the network entity 205 may be aware that any measurements that the UE 215 performs based on such downlink communications may be biased due to the potential self-interference 225. In some cases, the UE 215 may determine to transmit the notification to the network entity 205 based on determining that a priority associated with a downlink transmission scheduled to use the receive beam 540 is the same as a priority associated with an uplink transmission scheduled to use the transmit beam 530.

Additionally, or alternatively, the one or more self-interference mitigation techniques may include dropping an uplink transmission scheduled to use the transmit beam 530 or dropping a downlink transmission scheduled to use the receive beam 540. The UE 215 may determine which of the uplink or the downlink transmission to drop based on a priority associated with each. For instance, based on determining that a priority associated with the uplink transmission is higher than a priority associated with the downlink transmission, the downlink transmission may be dropped. On the other hand, if a priority associated with the downlink transmission is higher than a priority associated with the uplink transmission, then the uplink transmission may be dropped.

In some cases, the UE 215 may determine whether the transmit beam 530 and the receive beam 540 are sufficiently spatially separated based on a configuration of restricted pairs of transmit and receive beams. For instance, the UE 215 may be configured with a mapping of pairs of transmit and receive beams that are restricted from being used together. For instance, the network entity 205 may transmit control signaling including configuration information to the UE 215 including the mapping of the restricted pairs of transmit and receive beams. The control signaling may be transmitted via RRC signaling, DCI, MAC-CE signaling, other control signaling, or a combination thereof. When the UE 215 receives a downlink transmission, such as an SSB, CSI-RS, or tracking signal via a receive beam 540, the UE 215 may determine, based on configuration of the restricted pairs, one or more transmit beams 530 that are restricted from use with the receive beam 540. If the uplink transmission is scheduled to be transmitted with one of the transmit beams 530 determined to be restricted for use with the receive beam 540, the UE 215 may perform one or more of the above-discussed self-interference mitigation techniques.

In some cases, the above-described self-interference threshold requirements related to sufficient separation in the spatial domain may be used together with one or both of the self-interference threshold requirements related to sufficient separation in the frequency domain, as described with respect to FIG. 3, and/or the self-interference threshold requirements related to sufficient separation in the time domain, as described with respect to FIG. 4.

FIG. 6 shows an example of a communication resource configuration 600 that supports uplink transmission during reference signal reception in full-duplex communication in accordance with one or more aspects of the present disclosure.

In the communication resource configuration 600, the UE 215 may receive, from the network entity 205, control signaling including a scheduling grant 260 allocating uplink resources and downlink resources to the UE 215 for full-duplex communication. The uplink resources and the downlink resources may include time resources (such as an allocation of time slots, symbols, or the like), frequency resources (such as an allocation of frequency bands, resource blocks, resource elements, or the like), and spatial resources (such as an allocation of spatial channels, beams, or the like).

In some cases, the allocated resources may be for SBFD communication in particular, where the UE 215 may transmit and receive data using a same time resource (or at least a portion of the same time resource), but different frequency resources, such as uplink resources 630 and downlink resource 640 (not shown). For the SBFD communication, the uplink and downlink resources may be placed in different portions (e.g., sub-bands) of the same frequency band. In some cases, the uplink and downlink frequency resources may be separated by a guard band to mitigate self-interference 225 at the UE 215 during the SBFD communication. In some cases, the uplink and downlink resource may not be separated by a guard band. In some cases, a start of the uplink and downlink time resources may be separated by a time offset to mitigate self-interference 225 at the UE 215 during the SBFD communication. In some cases, there may be no time offset separating a start of the uplink and downlink time resources. In some cases, uplink and downlink spatial resources may be separated by a spatial separation amount to mitigate self-interference 225 at the UE 215 during the SBFD communication. In some cases, the uplink and downlink spatial resources may not be separated by a spatial separation amount. In some cases, the UE 215 may utilize a certain a transmit power level for transmitting an uplink transmission using the uplink resources 630 to mitigate self-interference 225 at the UE 215 during the SBFD communication.

In some cases, the control signaling including the scheduling grant may additionally include control information indicating a first set of parameters, a second set of parameters, one or more self-interference thresholds, or a combination thereof to be used for the full-duplex communication. In some cases, the control information may be received, from the network entity 205, in separate control signaling.

The first set of parameters may be used for the full-duplex communication when a first set of conditions are met, and the second set of parameters may be used for the full-duplex communication when a second set of conditions are met, as described with respect to FIG. 2.

The one or more self-interference thresholds may include a self-interference threshold 650 associated with a transmit power level. The self-interference threshold 650 may be used to ensure that not more than a threshold amount of transmit power is used to transmit an uplink transmission associated with the uplink resource 630. That is, the self-interference threshold 650 may be used to determine whether a transmit power level amount 690 associated with an uplink transmission using the uplink resources 630 is sufficient to mitigate self-interference 225 at the UE 215 during full-duplex communication. The self-interference threshold 650 may indicate a transmit power level, such as transmit power level n, and the self-interference threshold 650 may be compared with the transmit power level amount 690 to determine whether the transmit power level amount 690 may cause self-interference during the full-duplex communication.

In some cases, if the transmit power level amount 690 associated with an uplink transmission using the uplink resources 630 is less than the self-interference threshold 650 (e.g., does not satisfy the self-interference threshold 650), the UE 215 may determine that the transmit power level is sufficient to mitigate self-interference 225 at the UE 215 and the UE 215 may communicate concurrently, such as during at least a portion of a time resource, on the uplink resources 630 and the downlink resources 640. On the other hand, if the transmit power level amount 690 associated with an uplink transmission using the uplink resources 630 is greater than or equal to the self-interference threshold 650 (e.g., satisfies the self-interference threshold 650), the UE 215 may determine that the transmit power level is insufficient to mitigate self-interference 225 at the UE 215, and as a result, may communicate concurrently, such as during the at least a portion of the time resource, via the uplink resources 630 and the downlink resources 640, using the second set of parameters.

In some cases, when the UE 215 determines that the transmit power level amount 690 associated with an uplink transmission using the uplink resources 630 is greater than or equal to the self-interference threshold 650 (e.g., satisfies the self-interference threshold 650, where the transmit power level amount is insufficient to mitigate self-interference 225), the UE 215 may first determine whether a type of a downlink transmission scheduled for concurrent communication using the downlink resources 640 is of a restricted type of transmission. That is, in some cases, only certain types of transmissions may be restricted from full-duplex communication using the first set of parameters when the transmit power level amount 690 is insufficient to mitigate the self-interference 225 (e.g., when the self-interference threshold 650 is satisfied). For example, if the transmit power level amount 690 associated with a uplink transmission using the uplink resources 630 is greater than or equal to the self-interference threshold 650 (e.g., satisfies the self-interference threshold 650), and an uplink transmission scheduled for transmission using the uplink resources 630 corresponds to a PUSCH transmission, a PUCCH transmission, or an SRS, but a downlink transmission scheduled for reception using the downlink resources 640 does not correspond to one of the restricted types of transmissions, such as an SSB index configured for L1-RSRP measurement, a periodic CSI-RS configured for L1-RSRP measurement, a semi-persistent CSI-RS configured for L1-RSRP measurement when the semi-persistent CSI-RS resources are activated, or an aperiodic CSI-RS configured for L1-RSRP measurement when the UE 215 is triggered to measure at least a portion of the aperiodic CSI-RS resources, then the UE 215 may use the first set of parameters for the full-duplex communication via the uplink resources 630 and the downlink resources 640. On the other hand, if the transmit power level amount 690 associated with an uplink transmission using the uplink resources 630 is greater than or equal to the self-interference threshold 650 (e.g., satisfies the self-interference threshold 650), and the uplink transmission scheduled for transmission using the uplink resources 630 corresponds to a PUSCH transmission, a PUCCH transmission, or an SRS, and the downlink transmission scheduled for reception using the downlink resources 640 corresponds to one of the restricted types of transmissions, such as an SSB index configured for L1-RSRP measurement, a periodic CSI-RS configured for L1-RSRP measurement, a semi-persistent CSI-RS configured for L1-RSRP measurement when the semi-persistent CSI-RS resources are activated, or an aperiodic CSI-RS configured for L1-RSRP measurement when the UE 215 is triggered to measure at least a portion of the aperiodic CSI-RS resources, then the UE 215 may use the second set of parameters for the full-duplex communication via the uplink resources 630 and the downlink resources 640.

Use of the second set of parameters may enable the UE 215 to mitigate self-interference 225 during the full-duplex communication using the uplink resources 630 and the downlink resources 640 during at least a portion of a same time resource. Use of the first set of parameters may enable the UE 215 to perform the full-duplex communication using the uplink resources 630 and the downlink resources 640 during at least a portion of the same time resource without performing the one or more mitigation techniques.

The UE 215 may determine which of the one or more self-interference mitigation techniques to use based, at least in part, on a priority associated with an uplink transmission scheduled to use the uplink resources 630, a priority associated with a downlink transmission scheduled to use the downlink resources 640, or both. The one or more mitigation techniques may include adjusting the transmit power level associated with the uplink transmission scheduled to use the uplink resources 630. For instance, the adjusting may cause the transmit power level amount 690 to be less than the self-interference threshold 650. In some cases, the UE 215 may determine to perform the adjusting based on determining that a priority associated with a downlink transmission scheduled to use the downlink resources 640 is higher than a priority associated with an uplink transmission scheduled to use the uplink resources 630.

Additionally, or alternatively, the one or more self-interference mitigation techniques may include transmitting, to the network entity 205, a message including a notification that uplink and downlink transmissions associated with the uplink resources 630 and the downlink resources 640 occurred during at least a portion of the same time resource while the transmit power level amount 690 was insufficient to mitigate self-interference 225 at the UE 215 (e.g., when the self-interference threshold 650 is satisfied). In this way, the network entity 205 may be aware that any measurements that the UE 215 performs based on such downlink communications may be biased due to the potential self-interference 225 at the UE 215. In some cases, the UE 215 may determine to transmit the notification to the network entity 205 based on determining that a priority associated with a downlink transmission scheduled to use downlink resources 640 is the same as a priority associated with an uplink transmission scheduled to use the uplink resources 630.

Additionally, or alternatively, the one or more self-interference mitigation techniques may include dropping an uplink transmission scheduled to use the uplink resources 630 or dropping a downlink transmission scheduled to use the downlink resources 640. The UE 215 may determine which of the uplink or the downlink transmission to drop based on a priority associated with each. For instance, based on determining that a priority associated with the uplink transmission is higher than a priority associated with the downlink transmission, the downlink transmission may be dropped. On the other hand, if a priority associated with the downlink transmission is higher than a priority associated with the uplink transmission, then the uplink transmission may be dropped.

In some cases, the above-described self-interference threshold requirements related to sufficient separation in transmit power may be used together with one or more of the self-interference threshold requirements related to sufficient separation in the frequency domain, as described with respect to FIG. 3, the self-interference threshold requirements related to sufficient separation in the time domain, as described with respect to FIG. 4, and/or the self-interference threshold requirements related to sufficient separation in the spatial domain, as described with respect to FIG. 5.

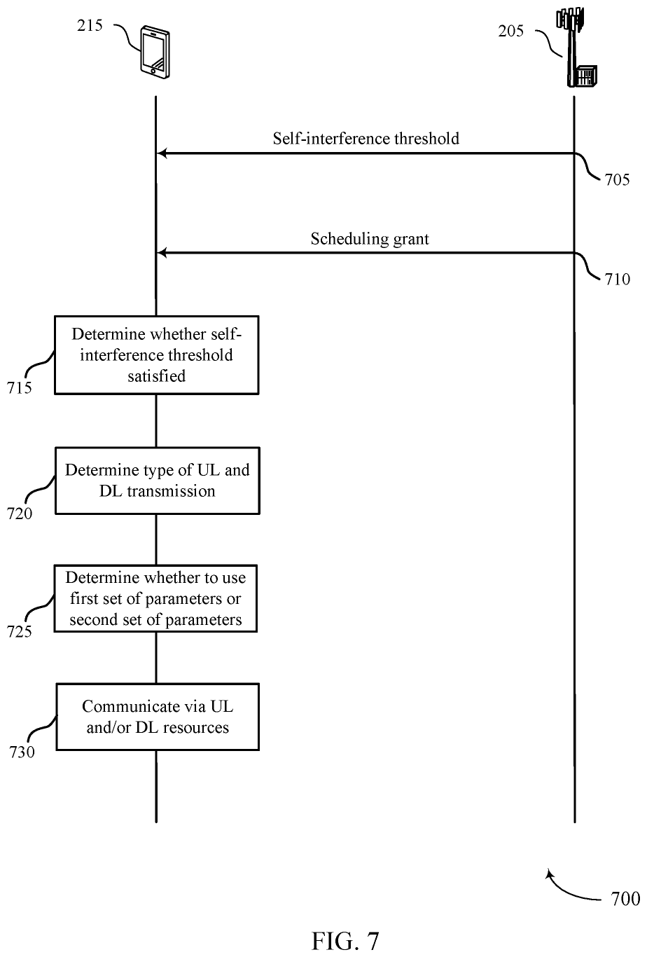

FIG. 7 shows an example of a process flow 700 that supports uplink transmission during reference signal reception in full-duplex communication in accordance with one or more aspects of the present disclosure.

In some examples, process flow 700 may implement aspects of or may be implemented by aspects of wireless communications system 100, wireless communications system 200, or both. Process flow 700 may be implemented by a UE 215 and a network entity 205 as described herein. In the following description of the process flow 700, the communications between the UE 215 and the network entity 205 may be transmitted in a different order than the example order shown, or the operations performed by the UE 215 and network entity 205 may be performed in different orders or at different times. Some operations may also be omitted from the process flow 700, and other operations may be added to the process flow 700.

In some examples, the operations illustrated in process flow 700 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 705, the network entity 205 may transmit, to the UE 215, control information indicating a self-interference threshold for full-duplex communication. In some cases, the control information may indicate a plurality of self-interference thresholds and the plurality of self-interference thresholds may correspond to different thresholds for measuring separation at different domains, such as at a frequency domain, a time domain, or a spatial domain. In some cases, the plurality of self-interference thresholds may correspond to a characteristic associated with the full-duplex communication, such as a transmit power level associated with an uplink transmission. In some cases, the plurality of self-interference thresholds may correspond to different thresholds associated with different classes of full-duplex devices, different types of signals, or different channels. In some cases, the control information may additionally include a first set of parameters, a second set of parameters, or both. The first and second sets of parameters may be used by the UE 215 for communicating during the full-duplex communication. The control information may be transmitted via control signaling such as RRC signaling, DCI, MAC-CE, signaling, other control signaling, or a combination thereof.

At step 710, the network entity 205 may transmit, to the UE 215, a control message including a grant scheduling uplink and downlink resources for the full-duplex communication. The uplink resources and the downlink resources may include time resources (such as an allocation of time slots, symbols, or the like), frequency resources (such as an allocation of frequency bands, resource blocks, resource elements, or the like), and spatial resources (such as an allocation of spatial channels, beams, or the like). The allocated resources may be scheduled for uplink and downlink communication within a same time resource, or at least a portion of a same time resource. The scheduling grant may be transmitted via a downlink control channel, such as a physical downlink control channel (PDCCH), or via downlink control information (DCI). In some cases, the control information including the self-interference threshold may be transmitted together with the scheduling grant.

At step 715, the UE 215 may determine whether the uplink resources, downlink resources, information associated with such resources, or a combination thereof satisfy the self-interference threshold, such as described with respect to FIGS. 2 through 6. As an example, the self-interference threshold may indicate a quantity of resource elements that may be used to ensure that the uplink and downlink resources are sufficiently separated so as to mitigate self-interference at the UE 215. The self-interference threshold may be compared with a quantity of resource elements associated with a guard band between the uplink and downlink resources. The UE 215 may determine whether the quantity of resource elements associated with the guard band is less than or equal to the self-interference threshold. If the quantity of resource elements associated with the guard band is less than or equal to the self-interference threshold, the UE 215 may determine that the self-interference threshold is satisfied. In some cases, when there is a plurality of self-interference thresholds, the UE 215 may determine whether one or more of the self-interference thresholds are satisfied.

At 720, if the self-interference threshold is satisfied (e.g., there is insufficient separation between the uplink and downlink resources to mitigate self-interference at the UE 215), the UE 215 may determine a type of the uplink transmission scheduled for transmission using the uplink resources. For instance, the UE 215 may determine whether the uplink transmission is one of a PUCCH, PUSCH, or SRS. The UE 215 may additionally determine a type of the downlink transmission scheduled for transmission using the downlink resources. For instance, the UE 215 may determine whether the downlink transmission is one of a restricted type of downlink transmission, such as an SSB index configured for L1-RSRP measurement, a periodic CSI-RS configured for L1-RSRP measurement, a semi-persistent CSI-RS configured for L1-RSRP measurement when the semi-persistent CSI-RS resources are activated, or an aperiodic CSI-RS configured for L1-RSRP measurement when the UE 215 is triggered to measure at least a portion of the aperiodic CSI-RS resources. If the self-interference threshold is not satisfied (e.g., there is sufficient separation between the uplink and downlink resources to mitigate self-interference at the UE 215), then step 720 may be optional and may not be performed by UE 215.

At 725, the UE 215 may determine whether to use a first set of parameters or a second set of parameters to communicate during the full-duplex communication. For instance, if the self-interference threshold is satisfied (e.g., there is insufficient separation between the uplink and downlink resources to mitigate self-interference at the UE 215), and the uplink transmission is determined to be one of a PUCCH, PUSCH, or SRS, and the downlink transmission is determined to be one of the above-noted restricted types of downlink transmissions, the UE 215 may determine to communicate during the full-duplex communication using the second set of parameters.

In other cases, the UE may determine to communicate during the full-duplex communication using the first set of parameters. In some cases, the first set of parameters may be a default set of parameters for communicating during the full-duplex communication. For instance, if the self-interference threshold is satisfied, and the uplink transmission is determined to be one of a PUCCH, PUSCH, or SRC, and the downlink transmission is determined to be a type of transmission other than one of the above-noted restricted types of downlink transmissions, the UE 215 may determine to communicate using the first set of parameters. Additionally, if the self-interference threshold is not satisfied (e.g., there is sufficient separation between the uplink and downlink resources to mitigate self-interference at the UE 215), then the UE 215 may determine to communicate using the first set of parameters.

At step 730, the UE 215 may communicate via the uplink resources and/or the downlink resources within the time resource using the determined first set or second set of parameters. For instance, communicating using the second set of parameters may cause one or more mitigation techniques to be used to mitigate self-interference at the UE 215 during the full-duplex communication using the uplink and downlink resources within a same time resource (or a portion of a same time resource), as described with reference to FIGS. 2 through 6. Communicating using the first set of parameters may enable the full-duplex communication using the uplink and downlink resources within the same time resource (or a portion of a same time resource) without using the or more mitigation techniques.

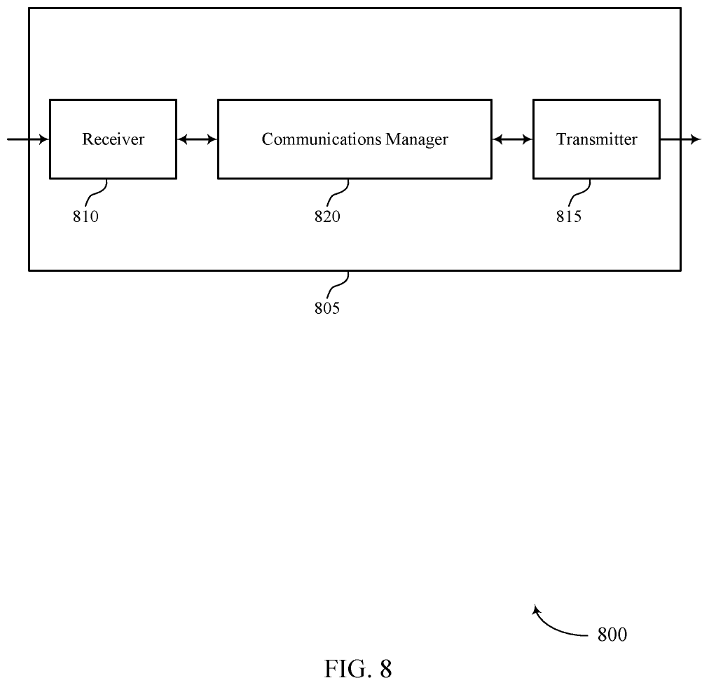

FIG. 8 shows a block diagram 800 of a device 805 that supports uplink transmission during reference signal reception in full-duplex communication in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to uplink transmission during reference signal reception in full-duplex communication). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to uplink transmission during reference signal reception in full-duplex communication). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of uplink transmission during reference signal reception in full-duplex communication as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving control information indicating a self-interference threshold for full-duplex communication during reception of a reference signal. The communications manager 820 is capable of, configured to, or operable to support a means for receiving a scheduling grant allocating uplink resources and downlink resources for full-duplex communication within a time resource using a first set of parameters. The communications manager 820 is capable of, configured to, or operable to support a means for communicating via the uplink resources and the downlink resources within the time resource using a second set of parameters based on the uplink resources and the downlink resources satisfying the self-interference threshold.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources.

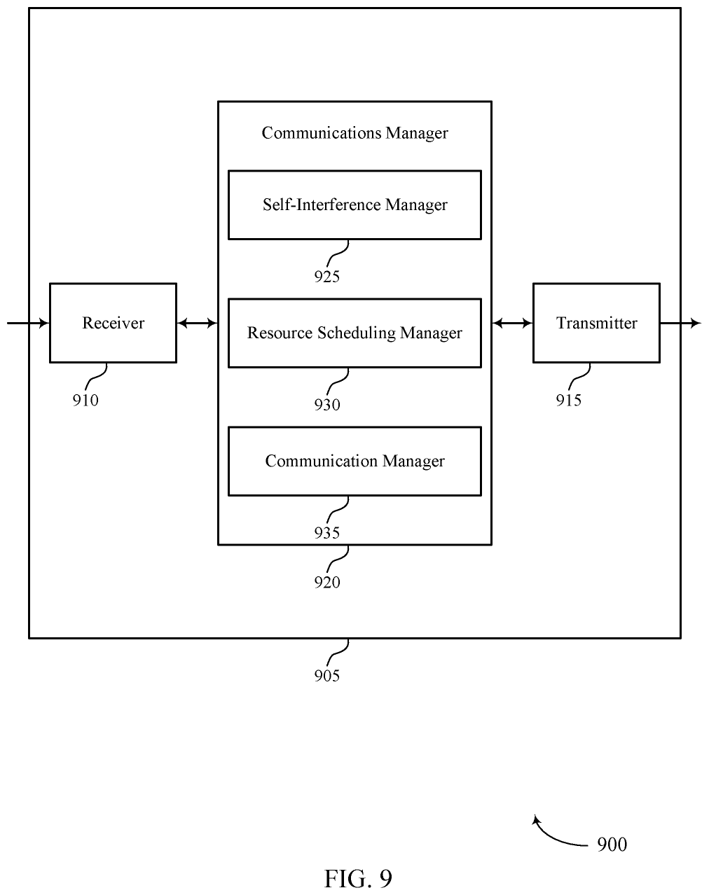

FIG. 9 shows a block diagram 900 of a device 905 that supports uplink transmission during reference signal reception in full-duplex communication in accordance with one or more aspects of the present disclosure. The device 905 may be an example of aspects of a device 805 or a UE 115 as described herein. The device 905 may include a receiver 910, a transmitter 915, and a communications manager 920. The device 905, or one of more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to uplink transmission during reference signal reception in full-duplex communication). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to uplink transmission during reference signal reception in full-duplex communication). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of uplink transmission during reference signal reception in full-duplex communication as described herein. For example, the communications manager 920 may include a self-interference manager 925, a resource scheduling manager 930, a communication manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The self-interference manager 925 is capable of, configured to, or operable to support a means for receiving control information indicating a self-interference threshold for full-duplex communication during reception of a reference signal. The resource scheduling manager 930 is capable of, configured to, or operable to support a means for receiving a scheduling grant allocating uplink resources and downlink resources for full-duplex communication within a time resource using a first set of parameters. The communication manager 935 is capable of, configured to, or operable to support a means for communicating via the uplink resources and the downlink resources within the time resource using a second set of parameters based on the uplink resources and the downlink resources satisfying the self-interference threshold.

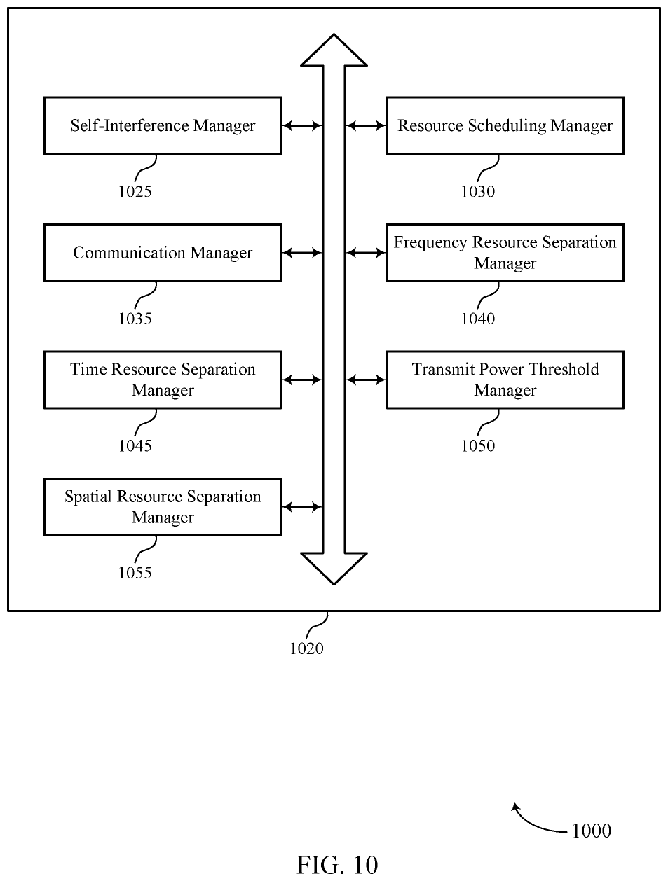

FIG. 10 shows a block diagram 1000 of a communications manager 1020 that supports uplink transmission during reference signal reception in full-duplex communication in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of uplink transmission during reference signal reception in full-duplex communication as described herein. For example, the communications manager 1020 may include a self-interference manager 1025, a resource scheduling manager 1030, a communication manager 1035, a frequency resource separation manager 1040, a time resource separation manager 1045, a transmit power threshold manager 1050, a spatial resource separation manager 1055, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The self-interference manager 1025 is capable of, configured to, or operable to support a means for receiving control information indicating a self-interference threshold for full-duplex communication during reception of a reference signal. The resource scheduling manager 1030 is capable of, configured to, or operable to support a means for receiving a scheduling grant allocating uplink resources and downlink resources for full-duplex communication within a time resource using a first set of parameters. The communication manager 1035 is capable of, configured to, or operable to support a means for communicating via the uplink resources and the downlink resources within the time resource using a second set of parameters based on the uplink resources and the downlink resources satisfying the self-interference threshold.

In some examples, to support communicating via the uplink resources and the downlink resources using the second set of parameters, the communication manager 1035 is capable of, configured to, or operable to support a means for transmitting an uplink communication using the uplink resources during the time resource while concurrently receiving the reference signal using the downlink resources during the time resource.

In some examples, the frequency resource separation manager 1040 is capable of, configured to, or operable to support a means for determining that a quantity of resource elements between a first resource element associated with the uplink resources and a second resource element associated with the downlink resources is less than a threshold quantity of resource elements, where the self-interference threshold includes the threshold quantity of resource elements.

In some examples, the time resource separation manager 1045 is capable of, configured to, or operable to support a means for determining that the uplink resources and the downlink resources overlap in the time resource by a quantity of symbols that is less than a threshold quantity of symbols, where the self-interference threshold includes the threshold quantity of symbols.

In some examples, the transmit power threshold manager 1050 is capable of, configured to, or operable to support a means for determining that a transmit power associated with an uplink communication associated with the uplink resources is greater than a threshold transmit power level, where the self-interference threshold includes the threshold transmit power level.

In some examples, the spatial resource separation manager 1055 is capable of, configured to, or operable to support a means for determining that a spatial separation between a transmit beam associated with the uplink resources and a receive beam associated with the downlink resources is less than a threshold spatial separation, where the self-interference threshold includes the threshold spatial separation.

In some examples, the spatial resource separation manager 1055 is capable of, configured to, or operable to support a means for determining, based on a receive beam used to receive the reference signal using the downlink resources, one or more restricted uplink beams. In some examples, the spatial resource separation manager 1055 is capable of, configured to, or operable to support a means for determining a transmit beam associated with an uplink transmission using the uplink resources. In some examples, the spatial resource separation manager 1055 is capable of, configured to, or operable to support a means for determining that the uplink resources and the downlink resources satisfy the self-interference threshold based on determining that the transmit beam is included in the one or more restricted uplink beams.

In some examples, to support communicating via the uplink resources and the downlink resources using the second set of parameters, the communication manager 1035 is capable of, configured to, or operable to support a means for puncturing a portion of the uplink resources to increase a quantity of resource elements between the uplink resources and the downlink resources within the time resource.

In some examples, to support communicating via the uplink resources and the downlink resources using the second set of parameters, the communication manager 1035 is capable of, configured to, or operable to support a means for shifting a portion of the uplink resources to increase a quantity of resource elements between the uplink resources and the downlink resources within the time resource.

In some examples, to support communicating via the uplink resources and the downlink resources using the second set of parameters, the communication manager 1035 is capable of, configured to, or operable to support a means for adjusting a transmit power of an uplink transmission associated with the uplink resources.

In some examples, to support communicating via the uplink resources and the downlink resources using the second set of parameters, the communication manager 1035 is capable of, configured to, or operable to support a means for adjusting a transmit beam associated with an uplink transmission associated with the uplink resources.

In some examples, to support communicating via the uplink resources and the downlink resources using the second set of parameters, the communication manager 1035 is capable of, configured to, or operable to support a means for transmitting control signaling including a message indicating that the self-interference threshold was satisfied.

In some examples, the uplink resources include symbols corresponding to a physical uplink control channel transmission, a physical uplink shared channel transmission, or a sounding reference signal.

In some examples, the downlink resources include symbols corresponding to a synchronization signal block index configured for layer 1 reference signal received power measurement, a periodic channel-state information reference signal resource configured for layer 1 reference signal received power measurement, or a combination thereof.

In some examples, the downlink resources include symbols corresponding to semi-persistent channel-state information reference signal resources configured for layer 1 reference signal received power measurement. In some examples, the semi-persistent channel-state information reference signal resources are activated.

In some examples, the downlink resources include symbols corresponding to aperiodic channel-state information reference signal resources configured for layer 1 reference signal received power measurement. In some examples, the UE is triggered to measure at least a portion of the aperiodic channel-state information reference signal resources.

In some examples, the control information is received via radio resource control signaling, medium access control-control element signaling, downlink control information signaling, or a combination thereof.

In some examples, the UE includes sub-band full-duplex capabilities.

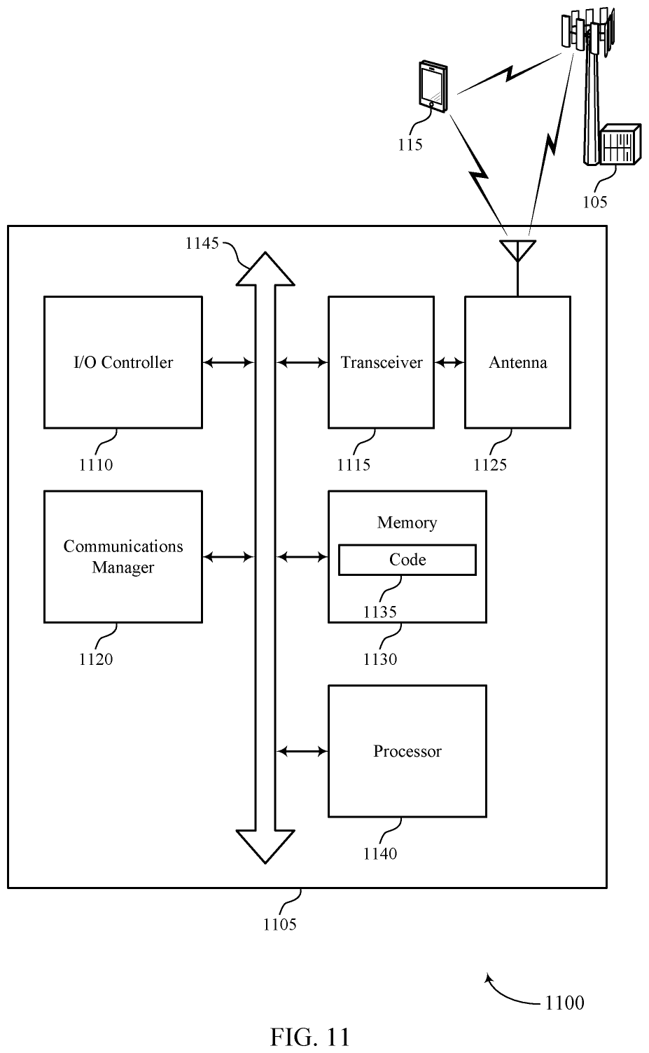

FIG. 11 shows a diagram of a system 1100 including a device 1105 that supports uplink transmission during reference signal reception in full-duplex communication in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable code 1135 including instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may contain, among other things, a basic I/O system (BIOS) which may control basic hardware or software operation such as the interaction with peripheral components or devices.

The at least one processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting uplink transmission during reference signal reception in full-duplex communication). For example, the device 1105 or a component of the device 1105 may include at least one processor 1140 and at least one memory 1130 coupled with or to the at least one processor 1140, the at least one processor 1140 and at least one memory 1130 configured to perform various functions described herein. In some examples, the at least one processor 1140 may include multiple processors and the at least one memory 1130 may include multiple memories. One or more of the multiple processors may be coupled with one or more of the multiple memories, which may, individually or collectively, be configured to perform various functions herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. As such, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving control information indicating a self-interference threshold for full-duplex communication during reception of a reference signal. The communications manager 1120 is capable of, configured to, or operable to support a means for receiving a scheduling grant allocating uplink resources and downlink resources for full-duplex communication within a time resource using a first set of parameters. The communications manager 1120 is capable of, configured to, or operable to support a means for communicating via the uplink resources and the downlink resources within the time resource using a second set of parameters based on the uplink resources and the downlink resources satisfying the self-interference threshold.

By including or configuring the communications manager 1120 in accordance with examples as described herein, the device 1105 may support techniques for improved communication reliability, more efficient utilization of communication resources, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of uplink transmission during reference signal reception in full-duplex communication as described herein, or the at least one processor 1140 and the at least one memory 1130 may be otherwise configured to, individually or collectively, perform or support such operations.

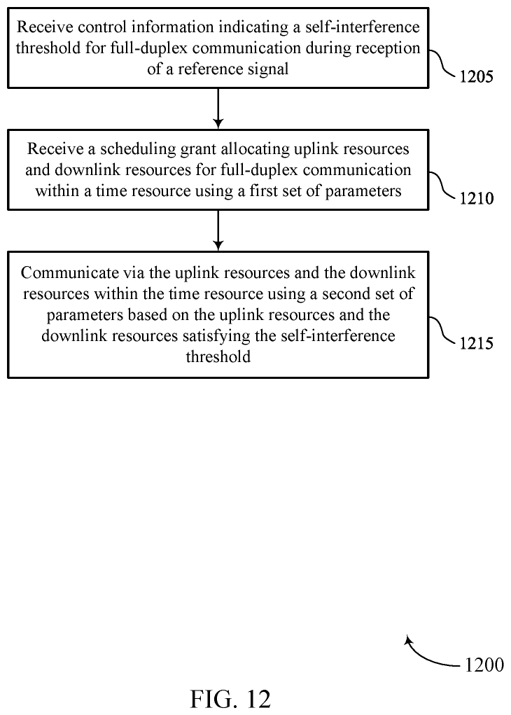

FIG. 12 shows a flowchart illustrating a method 1200 that supports uplink transmission during reference signal reception in full-duplex communication in accordance with aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving control information indicating a self-interference threshold for full-duplex communication during reception of a reference signal. The operations of block 1205 may be performed in accordance with examples as disclosed herein. In some examples, aspects of the operations of 1205 may be performed by a self-interference manager 1025 as described with reference to FIG. 10.

At 1210, the method may include receiving a scheduling grant allocating uplink resources and downlink resources for full-duplex communication within a time resource using a first set of parameters. The operations of block 1210 may be performed in accordance with examples as disclosed herein. In some examples, aspects of the operations of 1210 may be performed by a resource scheduling manager 1030 as described with reference to FIG. 10.

At 1215, the method may include communicating via the uplink resources and the downlink resources within the time resource using a second set of parameters based on the uplink resources and the downlink resources satisfying the self-interference threshold. The operations of block 1215 may be performed in accordance with examples as disclosed herein. In some examples, aspects of the operations of 1215 may be performed by a communication manager 1035 as described with reference to FIG. 10.

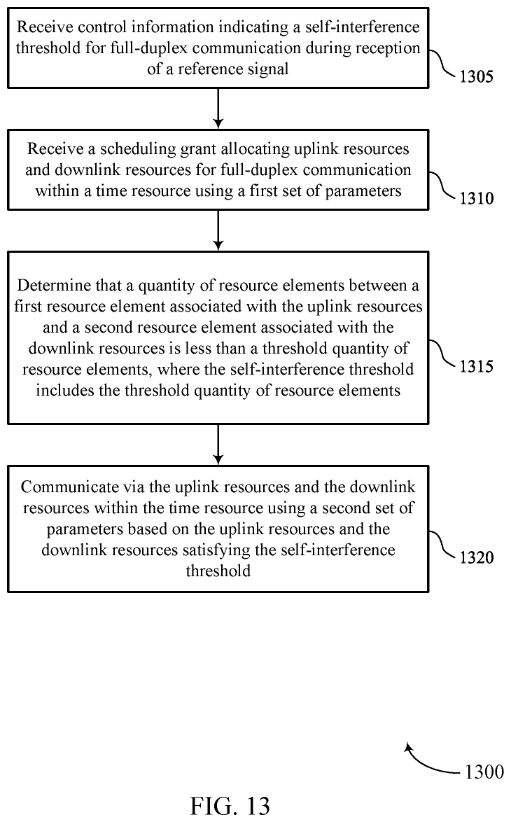

FIG. 13 shows a flowchart illustrating a method 1300 that supports uplink transmission during reference signal reception in full-duplex communication in accordance with aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving control information indicating a self-interference threshold for full-duplex communication during reception of a reference signal. The operations of block 1305 may be performed in accordance with examples as disclosed herein. In some examples, aspects of the operations of 1305 may be performed by a self-interference manager 1025 as described with reference to FIG. 10.

At 1310, the method may include receiving a scheduling grant allocating uplink resources and downlink resources for full-duplex communication within a time resource using a first set of parameters. The operations of block 1310 may be performed in accordance with examples as disclosed herein. In some examples, aspects of the operations of 1310 may be performed by a resource scheduling manager 1030 as described with reference to FIG. 10.

At 1315, the method may include determining that a quantity of resource elements between a first resource element associated with the uplink resources and a second resource element associated with the downlink resources is less than a threshold quantity of resource elements, where the self-interference threshold includes the threshold quantity of resource elements. The operations of block 1315 may be performed in accordance with examples as disclosed herein. In some examples, aspects of the operations of 1315 may be performed by a frequency resource separation manager 1040 as described with reference to FIG. 10.

At 1320, the method may include communicating via the uplink resources and the downlink resources within the time resource using a second set of parameters based on the uplink resources and the downlink resources satisfying the self-interference threshold. The operations of block 1320 may be performed in accordance with examples as disclosed herein. In some examples, aspects of the operations of 1320 may be performed by a communication manager 1035 as described with reference to FIG. 10.

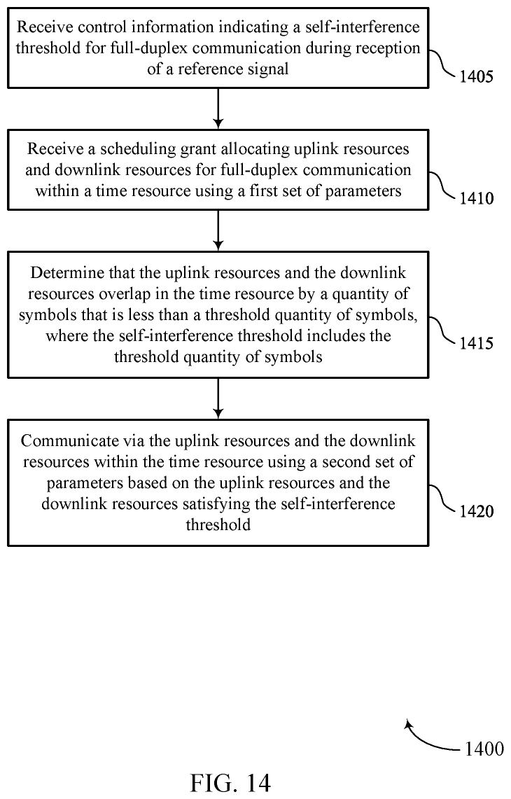

FIG. 14 shows a flowchart illustrating a method 1400 that supports uplink transmission during reference signal reception in full-duplex communication in accordance with aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include receiving control information indicating a self-interference threshold for full-duplex communication during reception of a reference signal. The operations of block 1405 may be performed in accordance with examples as disclosed herein. In some examples, aspects of the operations of 1405 may be performed by a self-interference manager 1025 as described with reference to FIG. 10.

At 1410, the method may include receiving a scheduling grant allocating uplink resources and downlink resources for full-duplex communication within a time resource using a first set of parameters. The operations of block 1410 may be performed in accordance with examples as disclosed herein. In some examples, aspects of the operations of 1410 may be performed by a resource scheduling manager 1030 as described with reference to FIG. 10.

At 1415, the method may include determining that the uplink resources and the downlink resources overlap in the time resource by a quantity of symbols that is less than a threshold quantity of symbols, where the self-interference threshold includes the threshold quantity of symbols. The operations of block 1415 may be performed in accordance with examples as disclosed herein. In some examples, aspects of the operations of 1415 may be performed by a time resource separation manager 1045 as described with reference to FIG. 10.

At 1420, the method may include communicating via the uplink resources and the downlink resources within the time resource using a second set of parameters based on the uplink resources and the downlink resources satisfying the self-interference threshold. The operations of block 1420 may be performed in accordance with examples as disclosed herein. In some examples, aspects of the operations of 1420 may be performed by a communication manager 1035 as described with reference to FIG. 10.

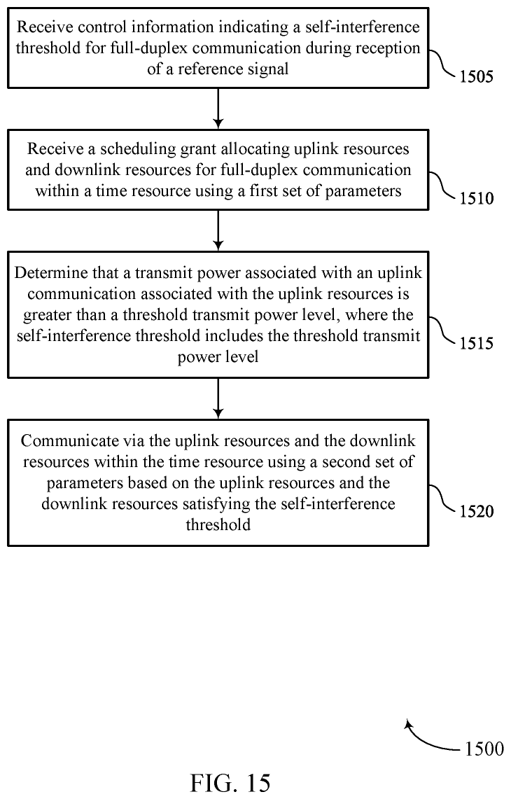

FIG. 15 shows a flowchart illustrating a method 1500 that supports uplink transmission during reference signal reception in full-duplex communication in accordance with aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1505, the method may include receiving control information indicating a self-interference threshold for full-duplex communication during reception of a reference signal. The operations of block 1505 may be performed in accordance with examples as disclosed herein. In some examples, aspects of the operations of 1505 may be performed by a self-interference manager 1025 as described with reference to FIG. 10.

At 1510, the method may include receiving a scheduling grant allocating uplink resources and downlink resources for full-duplex communication within a time resource using a first set of parameters. The operations of block 1510 may be performed in accordance with examples as disclosed herein. In some examples, aspects of the operations of 1510 may be performed by a resource scheduling manager 1030 as described with reference to FIG. 10.

At 1515, the method may include determining that a transmit power associated with an uplink communication associated with the uplink resources is greater than a threshold transmit power level, where the self-interference threshold includes the threshold transmit power level. The operations of block 1515 may be performed in accordance with examples as disclosed herein. In some examples, aspects of the operations of 1515 may be performed by a transmit power threshold manager 1050 as described with reference to FIG. 10.

At 1520, the method may include communicating via the uplink resources and the downlink resources within the time resource using a second set of parameters based on the uplink resources and the downlink resources satisfying the self-interference threshold. The operations of block 1520 may be performed in accordance with examples as disclosed herein. In some examples, aspects of the operations of 1520 may be performed by a communication manager 1035 as described with reference to FIG. 10.

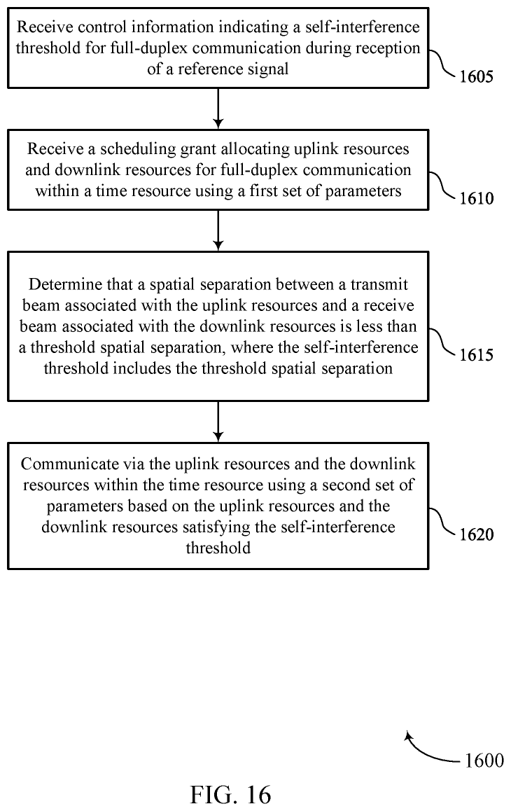

FIG. 16 shows a flowchart illustrating a method 1600 that supports uplink transmission during reference signal reception in full-duplex communication in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving control information indicating a self-interference threshold for full-duplex communication during reception of a reference signal. The operations of block 1605 may be performed in accordance with examples as disclosed herein. In some examples, aspects of the operations of 1605 may be performed by a self-interference manager 1025 as described with reference to FIG. 10.

At 1610, the method may include receiving a scheduling grant allocating uplink resources and downlink resources for full-duplex communication within a time resource using a first set of parameters. The operations of block 1610 may be performed in accordance with examples as disclosed herein. In some examples, aspects of the operations of 1610 may be performed by a resource scheduling manager 1030 as described with reference to FIG. 10.

At 1615, the method may include determining that a spatial separation between a transmit beam associated with the uplink resources and a receive beam associated with the downlink resources is less than a threshold spatial separation, where the self-interference threshold includes the threshold spatial separation. The operations of block 1615 may be performed in accordance with examples as disclosed herein. In some examples, aspects of the operations of 1615 may be performed by a s spatial resource separation manager 1055 as described with reference to FIG. 10.

At 1620, the method may include communicating via the uplink resources and the downlink resources within the time resource using a second set of parameters based on the uplink resources and the downlink resources satisfying the self-interference threshold. The operations of block 1620 may be performed in accordance with examples as disclosed herein. In some examples, aspects of the operations of 1620 may be performed by a communication manager 1035 as described with reference to FIG. 10.

The following provides an overview of aspects of the present disclosure:
Aspect 1: A method for wireless communications by a UE, comprising: receiving control information indicating a self-interference threshold for full-duplex communication during reception of a reference signal; receiving a scheduling grant allocating uplink resources and downlink resources for full-duplex communication within a time resource using a first set of parameters; and communicating via the uplink resources and the downlink resources within the time resource using a second set of parameters based at least in part on the uplink resources and the downlink resources satisfying the self-interference threshold.
Aspect 2: The method of aspect 1, wherein communicating via the uplink resources and the downlink resources using the second set of parameters comprises: transmitting an uplink communication using the uplink resources during the time resource while concurrently receiving the reference signal using the downlink resources during the time resource.
Aspect 3: The method of any of aspects 1 through 2, further comprising: determining that a quantity of resource elements between a first resource element associated with the uplink resources and a second resource element associated with the downlink resources is less than a threshold quantity of resource elements, wherein the self-interference threshold comprises the threshold quantity of resource elements.
Aspect 4: The method of any of aspects 1 through 2, further comprising: determining that the uplink resources and the downlink resources overlap in the time resource by a quantity of symbols that is less than a threshold quantity of symbols, wherein the self-interference threshold comprises the threshold quantity of symbols.
Aspect 5: The method of any of aspects 1 through 2, further comprising: determining that a transmit power associated with an uplink communication associated with the uplink resources is greater than a threshold transmit power level, wherein the self-interference threshold comprises the threshold transmit power level.
Aspect 6: The method of any of aspects 1 through 2, further comprising: determining that a spatial separation between a transmit beam associated with the uplink resources and a receive beam associated with the downlink resources is less than a threshold spatial separation, wherein the self-interference threshold comprises the threshold spatial separation.
Aspect 7: The method of any of aspects 1 through 6, further comprising: determining, based on a receive beam used to receive the reference signal using the downlink resources, one or more restricted uplink beams; determining a transmit beam associated with an uplink transmission using the uplink resources; and determining that the uplink resources and the downlink resources satisfy the self-interference threshold based at least in part on determining that the transmit beam is included in the one or more restricted uplink beams.
Aspect 8: The method of any of aspects 1 through 7, wherein communicating via the uplink resources and the downlink resources using the second set of parameters further comprises: puncturing a portion of the uplink resources to increase a quantity of resource elements between the uplink resources and the downlink resources within the time resource.
Aspect 9: The method of any of aspects 1 through 8, wherein communicating via the uplink resources and the downlink resources using the second set of parameters further comprises: shifting a portion of the uplink resources to increase a quantity of resource elements between the uplink resources and the downlink resources within the time resource.
Aspect 10: The method of any of aspects 1 through 9, wherein communicating via the uplink resources and the downlink resources using the second set of parameters further comprises: adjusting a transmit power of an uplink transmission associated with the uplink resources.
Aspect 11: The method of any of aspects 1 through 10, wherein communicating via the uplink resources and the downlink resources using the second set of parameters further comprises: adjusting a transmit beam associated with an uplink transmission associated with the uplink resources.
Aspect 12: The method of any of aspects 1 through 11, wherein communicating via the uplink resources and the downlink resources using the second set of parameters further comprises: transmitting control signaling comprising a message indicating that the self-interference threshold was satisfied.
Aspect 13: The method of any of aspects 1 through 12, wherein the uplink resources comprise symbols corresponding to a physical uplink control channel transmission, a physical uplink shared channel transmission, or a sounding reference signal.
Aspect 14: The method of any of aspects 1 through 13, wherein the downlink resources comprise symbols corresponding to a synchronization signal block index configured for layer 1 reference signal received power measurement, a periodic channel-state information reference signal resource configured for layer 1 reference signal received power measurement, or a combination thereof.
Aspect 15: The method of any of aspects 1 through 14, wherein the downlink resources comprise symbols corresponding to semi-persistent channel-state information reference signal resources configured for layer 1 reference signal received power measurement, and the semi-persistent channel-state information reference signal resources are activated.
Aspect 16: The method of any of aspects 1 through 15, wherein the downlink resources comprise symbols corresponding to aperiodic channel-state information reference signal resources configured for layer 1 reference signal received power measurement, and the UE is triggered to measure at least a portion of the aperiodic channel-state information reference signal resources.
Aspect 17: The method of any of aspects 1 through 16, wherein the control information is received via radio resource control signaling, medium access control-control element signaling, downlink control information signaling, or a combination thereof.
Aspect 18: The method of any of aspects 1 through 17, wherein the UE comprises sub-band full-duplex capabilities.
Aspect 19: A UE for wireless communications, comprising one or more memories storing processor-executable code, and one or more processors coupled with the one or more memories and individually or collectively operable to execute the code to cause the UE to perform a method of any of aspects 1 through 18.
Aspect 20: A UE for wireless communications, comprising at least one means for performing a method of any of aspects 1 through 18.
Aspect 21: A non-transitory computer-readable medium storing code for wireless communications, the code comprising instructions executable by one or more processors to perform a method of any of aspects 1 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control information indicating a self-interference threshold for full-duplex communication during reception of a reference signal;
receive a scheduling grant allocating uplink resources and downlink resources for full-duplex communication within a time resource using a first set of parameters; and
communicate via the uplink resources and the downlink resources within the time resource using a second set of parameters based at least in part on the uplink resources and the downlink resources satisfying the self-interference threshold.

2. The UE of claim 1, wherein, to communicate via the uplink resources and the downlink resources using the second set of parameters, the one or more processors are individually or collectively operable to execute the code to cause the UE to:
transmit an uplink communication using the uplink resources during the time resource while concurrently receiving the reference signal using the downlink resources during the time resource.

3. The UE of claim 1, wherein the one or more processors are individually or collectively further operable to execute the code to cause the UE to:
determine that a quantity of resource elements between a first resource element associated with the uplink resources and a second resource element associated with the downlink resources is less than a threshold quantity of resource elements, wherein the self-interference threshold comprises the threshold quantity of resource elements.

4. The UE of claim 1, wherein the one or more processors are individually or collectively further operable to execute the code to cause the UE to:
determine that the uplink resources and the downlink resources overlap in the time resource by a quantity of symbols that is less than a threshold quantity of symbols, wherein the self-interference threshold comprises the threshold quantity of symbols.

5. The UE of claim 1, wherein the one or more processors are individually or collectively further operable to execute the code to cause the UE to:
determine that a transmit power associated with an uplink communication associated with the uplink resources is greater than a threshold transmit power level, wherein the self-interference threshold comprises the threshold transmit power level.

6. The UE of claim 1, wherein the one or more processors are individually or collectively further operable to execute the code to cause the UE to:
determine that a spatial separation between a transmit beam associated with the uplink resources and a receive beam associated with the downlink resources is less than a threshold spatial separation, wherein the self-interference threshold comprises the threshold spatial separation.

7. The UE of claim 1, wherein the one or more processors are individually or collectively further operable to execute the code to cause the UE to:
determine, based on a receive beam used to receive the reference signal using the downlink resources, one or more restricted uplink beams;
determine a transmit beam associated with an uplink transmission using the uplink resources; and
determine that the uplink resources and the downlink resources satisfy the self-interference threshold based at least in part on determining that the transmit beam is included in the one or more restricted uplink beams.

8. The UE of claim 1, wherein, to communicate via the uplink resources and the downlink resources using the second set of parameters, the one or more processors are individually or collectively further operable to execute the code to cause the UE to:
puncture a portion of the uplink resources to increase a quantity of resource elements between the uplink resources and the downlink resources within the time resource,
shift a portion of the uplink resources to increase a quantity of resource elements between the uplink resources and the downlink resources within the time resource,
adjust a transmit power of an uplink transmission associated with the uplink resources,
adjust a transmit beam associated with an uplink transmission associated with the uplink resources, and
transmit control signaling comprising a message indicating that the self-interference threshold was satisfied.

9. The UE of claim 1, wherein the uplink resources comprise symbols corresponding to a physical uplink control channel transmission, a physical uplink shared channel transmission, or a sounding reference signal.

10. The UE of claim 1, wherein the downlink resources comprise symbols corresponding to a synchronization signal block index configured for layer 1 reference signal received power measurement, activated semi-persistent channel-state information reference signal resources configured for layer 1 reference signal received power measurement, a periodic channel-state information reference signal resource configured for layer 1 reference signal received power measurement, aperiodic channel-state information reference signal resources configured for layer 1 reference signal received power measurement, or a combination thereof.

11. The UE of claim 1, wherein the UE is triggered to measure at least a portion of the aperiodic channel-state information reference signal resources.

12. The UE of claim 1, wherein the control information is received via radio resource control signaling, medium access control-control element signaling, downlink control information signaling, or a combination thereof.

13. A method for wireless communications by a user equipment (UE), comprising:
receiving control information indicating a self-interference threshold for full-duplex communication during reception of a reference signal;
receiving a scheduling grant allocating uplink resources and downlink resources for full-duplex communication within a time resource using a first set of parameters; and
communicating via the uplink resources and the downlink resources within the time resource using a second set of parameters based at least in part on the uplink resources and the downlink resources satisfying the self-interference threshold.

14. The method of claim 13, further comprising:
determining that a quantity of resource elements between a first resource element associated with the uplink resources and a second resource element associated with the downlink resources is less than a threshold quantity of resource elements, wherein the self-interference threshold comprises the threshold quantity of resource elements.

15. The method of claim 13, further comprising:
determining that the uplink resources and the downlink resources overlap in the time resource by a quantity of symbols that is less than a threshold quantity of symbols, wherein the self-interference threshold comprises the threshold quantity of symbols.

16. The method of claim 13, further comprising:
determining that a transmit power associated with an uplink communication associated with the uplink resources is greater than a threshold transmit power level, wherein the self-interference threshold comprises the threshold transmit power level.

17. The method of claim 13, further comprising:
determining that a spatial separation between a transmit beam associated with the uplink resources and a receive beam associated with the downlink resources is less than a threshold spatial separation, wherein the self-interference threshold comprises the threshold spatial separation.

18. The method of claim 13, further comprising:
determining, based on a receive beam used to receive the reference signal using the downlink resources, one or more restricted uplink beams;
determining a transmit beam associated with an uplink transmission using the uplink resources; and
determining that the uplink resources and the downlink resources satisfy the self-interference threshold based at least in part on determining that the transmit beam is included in the one or more restricted uplink beams.

19. The method of claim 13, wherein communicating via the uplink resources and the downlink resources using the second set of parameters further comprises:
puncturing a portion of the uplink resources to increase a quantity of resource elements between the uplink resources and the downlink resources within the time resource,
shifting a portion of the uplink resources to increase a quantity of resource elements between the uplink resources and the downlink resources within the time resource,
adjusting a transmit power of an uplink transmission associated with the uplink resources,
adjusting a transmit beam associated with an uplink transmission associated with the uplink resources, or
transmitting control signaling comprising a message indicating that the self-interference threshold was satisfied.

20. A non-transitory computer-readable medium storing code for wireless communications, the code comprising instructions executable by one or more processors to:
receive control information indicating a self-interference threshold for full-duplex communication during reception of a reference signal;
receive a scheduling grant allocating uplink resources and downlink resources for full-duplex communication within a time resource using a first set of parameters; and
communicate via the uplink resources and the downlink resources within the time resource using a second set of parameters based at least in part on the uplink resources and the downlink resources satisfying the self-interference threshold.
